(19) United States
(12) Patent Application Publication
(10) Pub. No.: US 2017/0180980 A1
(43) Pub. Date: Jun. 22, 2017

(54) Complex Computing Operation for Determining Suitability of Data Presentation on a Mobile Device

(71) Applicant: Research Now Group, Inc., Plano, TX (US)

(72) Inventors: Melanie Denise Courtright, Richardson, TX (US); Roger William Streight, Scarborough (CA); Rodney Knowles, IV, Charleston, SC (US); Divesh Mirani, North York (CA); Jeremy Scott Antoniuk, Allen, TX (US); John R. Rothwell, Dallas, TX (US)

(21) Appl. No.: 15/345,443

(22) Filed: Nov. 7, 2016

Related U.S. Application Data
(63) Continuation of application No. PCT/US2015/029493, filed on May 6, 2015.
Application No. PCT/US2015/029493 is a continuation of application No. 14/273,402, filed on May 8, 2014.

(51) Int. Cl. H04W 8/22; H04W 4/06

(52) U.S. Cl. CPC H04W 8/22; H04W 4/06

(57) ABSTRACT

The present disclosure is generally related to systems, methods, and computer-readable storage devices for determining suitability of data presentation on a mobile device. An exemplary system is configured for receiving data descriptive of a communication to be distributed to a plurality of mobile devices; analyzing the data to identify one or more attributes of the communication; and generating a score for the communication based on the one or more attributes of the communication, wherein the score is representative of a suitability of the communication for presentation at a mobile device.

### TECHNICAL FIELD

The present disclosure is generally related to systems, methods, and computer-readable storage devices for determining suitability of data presentation on a mobile device.

### BACKGROUND

Presentation of data on mobile devices is subject to technical limitations of the mobile devices. Mobile devices present technical limitations in terms of their hardware, software, and the ways in which they are operated by mobile device users. Given these technical limitations, there is a need for a method to determine the suitability of data presentation on mobile devices.

### SUMMARY

Disclosed herein are systems, methods, and computer-readable storage devices for scoring communications deployed in a mobile environment. The scoring of a communication may be based on one or more attributes of the communication, such as whether the communication utilizes multimedia content, text size, use of open ended questions, a scalability of the communication, a length of the communication, etc. The communication score may be representative of a suitability of the communication for presentation at a mobile device. For example, a high communication score may indicate that the communication is suitable for presentation at a mobile device, and a low communication score may indicate that the communication is not suitable for presentation at a mobile device. By scoring the communications, a entity may increase a number of communications completed by mobile respondents (e.g., respondents that are interacting with communications using a mobile device), and may further increase effectiveness of subsequent communications administered by the entity.

Further, the entity may provide feedback to a client (e.g., an author, requestor, or originator of the communication) regarding the communication score. The feedback may include recommendations for improving the communication score. Improving the communication score may increase the effectiveness of the communication (e.g., by increasing a number of mobile respondents that complete the communication).

Additionally, improving the communication score may enable the client to gain access to a larger pool of respondents or a more meaningful pool of respondents. For example, the entity may only distribute a communication to the mobile respondents when the communication has communication score that satisfies a threshold communication score (e.g., indicating that the communication is suitable for presentation at a mobile device of a mobile respondent). Clients desiring to communication mobile respondents may use the feedback to reconfigure and/or reformat the communication in order to achieve a higher communication score, and to gain access to the mobile respondents. This may be beneficial for clients that desire to distribute targeted communications to respondents at particular locations (e.g., targeting a communication regarding brand recognition to a respondent at a retail store location that sells products associated with the brand). Furthermore, communications receiving scores indicating that the communications may not perform well on the mobile respondent devices (or particular groups of mobile respondent devices), or that may cause incorrect communication responses to be returned (as determined by the communication score), may be suppressed or improved to prevent erroneous or corrupt data from contaminating a pool of communication results.

In an aspect, a method includes receiving communication data descriptive of a communication to be distributed to a plurality of respondents, and analyzing the communication data to identify one or more attributes of the communication. The method may include generating a communication score for the communication based on the one or more attributes of the communication. The communication score may be representative of a suitability or effectiveness of the communication for presentation and/or data collection at a mobile device. The method may include determining distribution information for the communication based at least in part on the communication score, wherein the distribution information identifies a set of respondents of the plurality of respondents to receive the communication.

In another aspect, an apparatus includes a processor, and a memory communicatively coupled to the processor. The memory may store instructions that, when executed by the processor, cause the processor to perform operations that include receiving communication data descriptive of a communication to be distributed to a plurality of respondents. The operations may further include analyzing the communication data to identify one or more attributes of the communication, and generating a communication score for the communication based on the one or more attributes of the communication. The communication score may represent of a suitability of the communication for presentation at a mobile device. The operations may further include determining distribution information for the communication based at least in part on the communication score. The distribution information may identify a set of respondents of the plurality of respondents to receive the communication.

In yet another aspect, a computer-readable storage device stores instructions that, when executed by a processor, cause the processor to perform operations that include receiving communication data descriptive of a communication to be distributed to a plurality of respondents. The operations may further include analyzing the communication data to identify one or more attributes of the communication, and generating a communication score for the communication based on the one or more attributes of the communication. The communication score may be representative of a suitability of the communication for presentation at a mobile device. The operations may further include determining distribution information for the communication based at least in part on the communication score. The distribution information may identify a set of respondents of the plurality of respondents to receive the communication. The set of respondents may be determined based on particular types of mobile respondent devices (e.g. tablet computing devices vs. smartphones), or may be restricted based on the particular types of mobile respondent devices, for example. Advantageously, communications having a generated communication score below a pre-determined threshold may be prevented from being distributed to mobile respondent devices or groups or types of mobile respondent devices.

The attributes of a communication may relate to any one or more of: how parts or all of a communication are communicated to one or more mobile respondent devices; how communication components are presented to a user of the one or more mobile respondent devices; the mechanism for collecting data from the user of the one or more mobile respondent devices; the accuracy of the collection mechanism in a mobile environment (or particular type of mobile environment); the computing resources required to execute the communication in the mobile device environment; whether the computing resources of the mobile respondent devices are sufficient for presentation of the communication; the data and bandwidth requirements needed to carry out the communication and collect the result data; and a screen area or resolution necessary to present the communication and accurately collect results from the one or more mobile respondent devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION

For a more complete understanding of the present disclosure, reference is now made to the following descriptions taken in conjunction with the accompanying figures, in which:

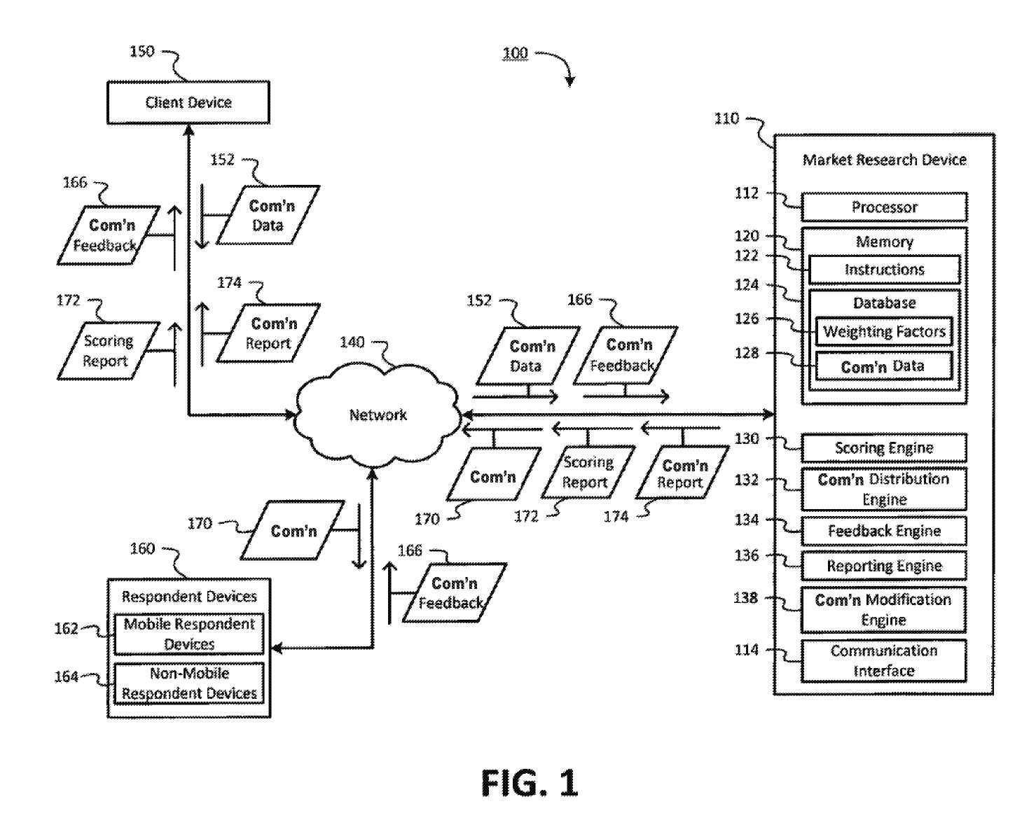

FIG. 1 is a block diagram of a system for scoring communications deployed in a mobile environment;

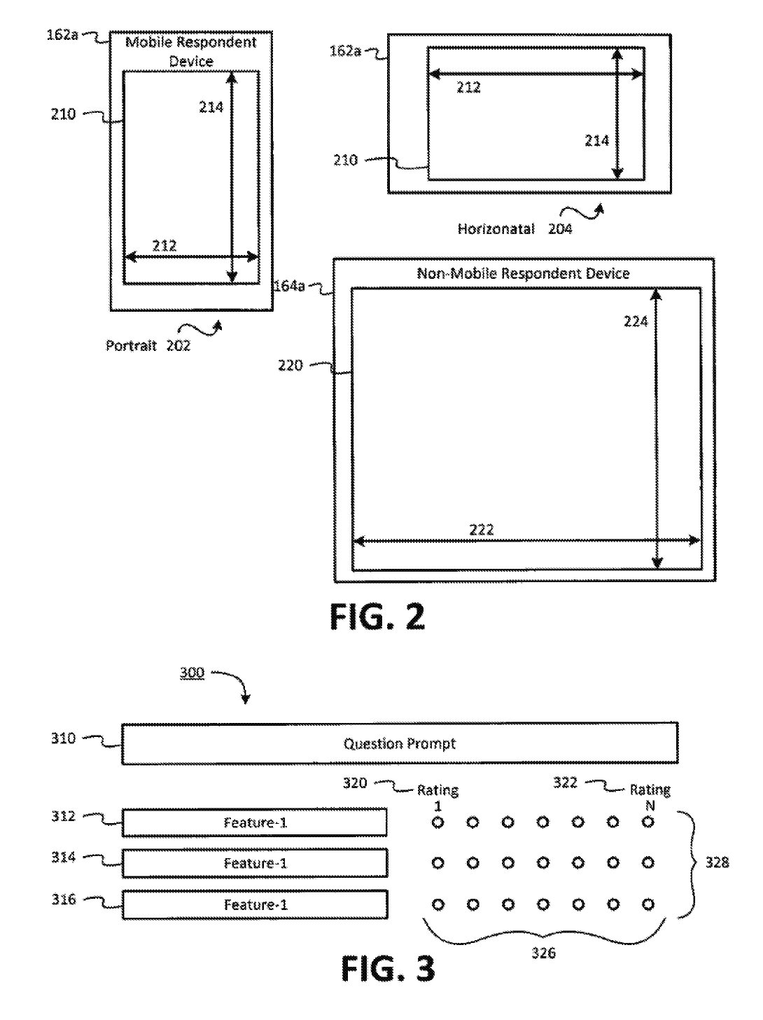

FIG. 2 is a block diagram illustrating aspects of display areas for mobile devices and non-mobile devices;

FIG. 3 is a block diagram illustrating exemplary aspects of a grid question;

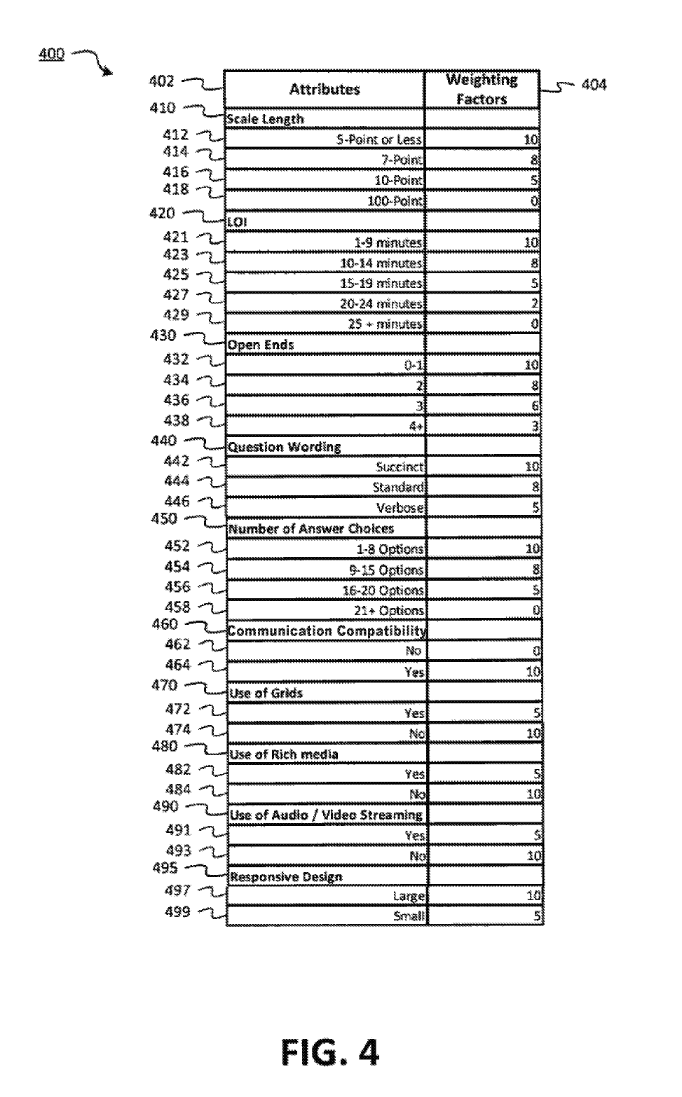

FIG. 4 is a block diagram illustrating exemplary aspects of identifying attributes of a communication and applying weighting factors to the attributes to determine a communication score; and

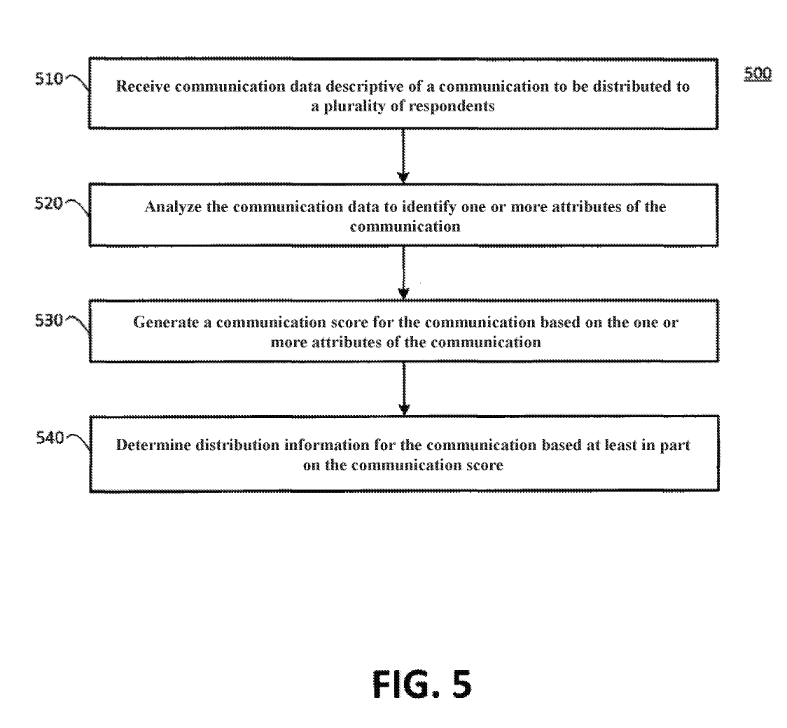

FIG. 5 is a flow chart of an exemplary method of determining whether a communication is suitable for distribution to a mobile respondent device.

### DETAILED DESCRIPTION

Referring to FIG. 1, a block diagram of a system for scoring communications deployed in a mobile environment is shown as system 100. As shown in FIG. 1, the system 100 includes a device 110, a client device 150, and respondent devices 160. The device 110 may be associated with a entity that may enroll a plurality of respondents (e.g., users of the respondent devices 160) in a program to answer communications in exchange for a reward (e.g., gift cards, discounts, money, rewards points, or another form of incentive). The communications may be provided to the entity by a client (e.g., a user of the client device 150) that desires feedback from the respondents regarding a product, a service, etc. The entity may distribute the communication to each of the enrolled respondents, or only to selected respondents (e.g., based on demographic information). The term “com′n” in any of the figures refers to “communication.”

The client device 150 may be a laptop computing device, a personal computing device, a tablet computing device, a smartphone, a personal digital assistant (PDA), a wireless communication device, or another electronic device operable to perform the operations of the client device 150, as described with reference to FIGS. 1-5. In an aspect, the device 110 may be integrated with the client device 150. For example, the entity may be a marketing group within a large company. In another aspect, the entity and the client are distinct entities, where the entity independently operates the device 110, and the client independently operates the client device 150.

The respondent devices 160 may correspond to electronic devices that are used by the enrolled respondents to receive and respond to communications. As shown in FIG. 1, the respondent devices 160 may include mobile respondent devices 162 and non-mobile respondent devices 164. The mobile respondent devices 162 may include a tablet computing device, a smartphone, a personal digital assistant (PDA), a wireless communication device, or another mobile device operable to perform the operations of the respondent devices 160, as described with reference to FIGS. 1-5. The non-mobile respondent devices 164 may include a laptop computing device, a personal computing device, a smart television device, a gaming console, or other electronic device operable to perform the operations of the respondent devices 160, as described with reference to FIGS. 1-5. In some aspects, a single enrolled respondent may utilize both a mobile respondent device 162 and a non-mobile respondent device 164 to answer communications.

As shown in FIG. 1, the device 110 includes a processor 112, a memory 120, a scoring engine 130, a communication distribution engine 132, a feedback engine 134, a reporting engine 136, a communication modification engine 138, and a communication interface 114. The memory 120 may store instructions 122. The instructions 122 may be executable by the processor 112 to perform operations of the device 110 according to one or more aspects of the present disclosure, as described with reference to FIGS. 1-5. The memory 120 may include random access memory (RAM) devices, read only memory (ROM) devices, one or more hard disk drives (HDDs), flash memory devices, solid state drives (SSDs), erasable programmable read only memory (EPROM) devices, electrically erasable programmable read only memory (EEPROM) devices, magneto-resistive random access memory (MRAM) devices, optical memory devices, cache memory devices, other memory devices configured to store data in a persistent or non-persistent state, or a combination of different memory devices. Further, the memory 120 may include computer-readable storage devices such as a compact disk (CD), a rewritable CD, a digital video disc (DVD), a re-rewritable DVD, etc.

The device 110 may be any electronic device (e.g., a laptop computing device, a personal computing device, a tablet computing device, a smartphone, a wireless communication device, a personal digital assistant (PDA), a gaming console, or another electronic device) operable to perform the operations described herein with reference to the device 110, as described with reference to FIGS. 1-5. Further, it is noted that the processor 112 may be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions of the device 110, as described with reference to FIGS. 1-5.

The communication interface 114 may be configured to communicatively couple the device 110 to one or more networks, such as a network 140, as shown in FIG. 1. The communication interface 114 may be configured to communicatively couple the device 110 to the network 140 according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3^{rd} generation (3G) protocol, a 4^{th} generation (4G) protocol, a long term evolution (LTE) protocol, etc.).

The network 140 may be a wired network, a wireless network, or may include a combination of wired and wireless networks. For example, the network 140 may be a local area network (LAN), a wide area network (WAN), a wireless WAN, a wireless LAN (WLAN), a metropolitan area network (MAN), a wireless MAN network, a cellular data network, a cellular voice network, the internet, etc. The device 110 may be in communication with the client device 150 and the respondent devices 160 via the network 140.

During operation, a client may generate communication data 152 using the client device 150. The communication data 152 may include information descriptive of a communication to be distributed to a plurality of respondents. The communication data 152 may be provided from the client device 150 to the device 110 via the network 140. In an aspect, the communication data 152 may be a web-link (e.g., a uniform resource locator (URL)) to a communication that is ready for distribution to the respondent devices 160. For example, the web-link may be provided to the respondent devices 160 via an e-mail message, via a short message service (SMS) message, a text message, etc. that includes the web-link, and the respondents may access a web page corresponding to the web-link using the respondent devices 160. Additional aspects of providing communications to the respondents and/or the respondent devices 160 are described below with reference to the communication distribution engine 132. In an additional or alternative aspect, the communication data 152 may include an extensible markup language (XML) file or set of XML files corresponding to a communication that is ready for distribution. Furthermore, other programming languages/methods may be used to generate the communication data 152.

Alternatively, the communication data 152 may be an incomplete communication or a communication that is not ready for distribution to the respondent devices 160. For example, the client may not have personnel that can create a webpage to facilitate a communication. Instead, the client may use the client device 150 to generate the communication data 152 including the information that is descriptive of the communication the client would like to provide to the respondent devices 160, and may provide the communication data 152 to the device 110 of the entity via the network 140. The entity may then create/program the communication for the client based on the information included in the communication data 152.

The communication data 152 may include branding information associated with a particular product or a particular service for which the client is seeking feedback, or other branding information associated with the client. The communication data 152 may also include demographic information identifying attributes of respondents from whom the client desires to receive the feedback. The feedback provided by the respondents may correspond to answers to the communication included in the communication data 152, or generated based on the communication data 152.

The device 110 may receive the communication data 152 and may store the communication data 152 in a database 124. As shown in FIG. 1, the database 124 may be stored at the memory 120. However, in an aspect, the database 124 may be stored at another device, such as a network attached storage (NAS) device communicatively coupled to the device 110, or may be stored at a storage area network (SAN) communicatively coupled to the device 110. Additionally or alternatively, the database 124 may be stored at a removable storage device (e.g., an external HDD, a flash drive, etc.) coupled to the device 110. Furthermore, the database 124 may be stored across multiple storage devices (e.g., in a redundant array of independent disks (RAID) configuration or across storage devices located at geographically disparate locations) integrated with or otherwise accessible to the device 110.

The communication described by or included in the communication data 152 may include a plurality of questions to be answered by the respondents. The plurality of questions may include various different types of questions. For example, the plurality of questions included in the communication may include open ended questions, multiple choice questions, and grid questions. It is noted that the communication may include other types of questions as well and these exemplary questions types have been identified and described herein for purposes of illustration, rather than limitation.

An open ended question may ask the respondent to provide his or her input by typing a response. For example, an open ended question may ask the respondent “What do you like about this product?” or “What could we do to make this service better?” In some instances, an open ended question may be combined with a multiple choice question. For example, a multiple choice question may provide the respondent with four (4) pre-determined answer choices and a fifth answer choice of “other.” When the respondent answers the question by selecting the fifth answer choice, the respondent may be asked to provide input explaining the meaning of “other.”

While mobile respondents (e.g., respondents answering communications using the mobile respondent devices 162) can and do respond to open ended questions included in communications, there is a notably higher drop off in responses to such questions from mobile respondents as compared to non-mobile respondents (e.g., respondents answering communications using the non-mobile respondent devices 164). Answers to open ended questions provided by mobile respondents tend to be shorter than answers to open ended questions provided by non-mobile respondents. However, the length of the responses to open ended questions does not necessarily indicate that the answers provided by the mobile-respondents are of less quality or are less meaningful to the client than the answers provided by the non-mobile-respondents. One or more aspects of the present disclosure provide systems and methods for improving the response rate to open ended questions by mobile respondents, as described in more detail below.

A grid question may provide a question and then prompt the respondent to answer the question by selecting a particular value within a range. For example, a grid question provided in a communication for a restaurant may ask the respondent “How would you rate your server?” The respondent may be asked to select an answer choice by a selection of a numeric value ranging from one (1) to ten (10), with one (1) indicating that the server provided the respondent with poor service, and with ten (10) indicating that the server provided the respondent with very good service. Intermediary numeric values within the range may indicate intermediate levels of service. For example, a selection of a numeric value of five (5) may indicate that the server provided the respondent with average service, and a selection of a numeric value of seven (7) may indicate that the server provided the respondent with good service.

While mobile respondents can and do respond to grid questions in communications, answering such questions on a mobile device (e.g., one of the mobile respondent device 162) may be more difficult when compared to answering such questions on a non-mobile device (e.g., one of the non-mobile respondent devices 164). For example, while both mobile devices and non-mobile devices include displays, a size of a display area for a display device (e.g., a touchscreen display integrated within a smartphone device) on a mobile device is typically smaller than a display area for a display device (e.g., a monitor coupled to a personal computing device) of a non-mobile device. For grid questions, the numeric values (or other types of range indicators) are typically provided as selectable inputs, such as using radio buttons, check boxes, or other selectable inputs. Due to the smaller display area on the mobile devices, it may be more difficult for the respondent to select a desired selectable input (e.g., using the respondent's finger), which may frustrate the respondent or cause the respondent to skip such questions. Additionally, the mobile respondents may be more likely to unknowingly select an incorrect one of the selectable inputs or fail to correct an incorrectly selected input. For example, the mobile respondent may have intended to select an input indicating a numeric value of seven (7), but due to the small display area on the mobile device, the mobile respondent may have selected an input indicating a numeric value of six (6). One or more aspects of the present disclosure provide systems and methods for improving the response rate to grid questions by mobile respondents and the accuracy of the responses made by mobile respondents, as described in more detail below.

The device 110 may be configured to analyze the communication data 152 to identify one or more attributes of the communication to be distributed to the respondent devices 160. For example, the scoring engine 130 may be configured to analyze the communication data 152 to identify the one or more attributes of the communication. In an aspect, the scoring engine 130 may detect receipt of the communication data 152 and may determine whether the communication data 152 is associated with a programmed communication (e.g., a communication that is ready for distribution to the respondent devices 160) or a non-programmed communication (e.g., a communication that is to be programmed by the entity prior to distribution to the respondent devices 160). When the scoring engine 130 determines that the communication data 152 is associated with a programmed communication, the scoring engine 130 may initiate analysis of the communication data 152. When the scoring engine 130 determines that the communication data 152 is associated with a non-programmed communication, the scoring engine 130 may flag an entry within the communication data 128 corresponding to the communication data 152. Upon programming the communication based on the communication data 152, the entry within the communication data 128 may be updated to include information associated with the newly programmed communication. Additionally, a second flag may be set to indicate that the communication has been programmed. The scoring engine 130 may periodically scan the entries within the communication data 128 for newly programmed communications (e.g., based on the second flag), and, in response to detecting the newly programmed communication, the scoring engine may initiate analysis of the newly programmed communication. In yet another aspect, the scoring engine 130 may initiate analysis of the non-programmed communication without waiting for the communication to be programmed. This may reduce a likelihood that additional programming or re-programming would be necessary after the communication is scored. Scoring of communications is described in more detail below.

During the analysis, the scoring engine 130 may identify one or more attributes of the communication. The one or more attributes may include an attribute associated with a scale length of the communication, an attribute associated with a length of interview (LOI) for the communication, an attribute associated with a wording of questions included in the communication, an attribute associated with a number of answer choices for the communication, an attribute indicating whether the communication is compatible with the mobile respondent devices 162, an attribute associated with utilization of grids in the communication, an attribute associated with use of rich media (e.g., images) in the communication, an attribute associated with use of audio/visual elements in the communication, an attribute associated with the responsive design of the communication, other attributes, or a combination of these attributes.

The attribute associated with the scale length of the communication may correspond to a number of scale points (e.g., in a grid question) or other communication information that may be presented within the display area at a single time. Communications are most commonly completed by respondents while viewing the communication in “portrait” mode (e.g., a vertical orientation). Due to the reduced display area on mobile devices, screen width may be even more of a premium than screen length.

To illustrate, and referring to FIG. 2, a block diagram illustrating aspects of display areas for mobile devices and non-mobile devices are shown. In FIG. 2, a mobile respondent device 162a (e.g., one of the mobile respondent devices 162 of FIG. 1) having a display area 210, and a non-mobile respondent device 164a (e.g., one of the non-mobile respondent devices 164 of FIG. 1) having a display area 220 are shown. Additionally, the mobile respondent device 162a is shown in both a portrait orientation 202 and a horizontal orientation 204. The display area 210 of the mobile device 162a has a width 212 and a height 214, and the display area 220 of the non-mobile device 164a has a width 222 and a height 224. As can be appreciated, when in the portrait orientation 202, the width 212 and the height 214 of the display area 210 of the mobile respondent device 162a are typically significantly smaller than the width 222 and the height 224 of the display area 220 of the non-mobile respondent device 164a. Additionally, even in the horizontal orientation 204, the width 212 and the height 214 of the display area 210 of the mobile respondent device 162a are typically significantly smaller than the width 222 and the height 224 of the display area 220 of the non-mobile respondent device 164a.

The mobile device 162a may support automatic re-orientation of information (e.g., selectable inputs to a grid question) presented in the display area 210 based on whether the mobile device 162a is oriented in the portrait orientation 202 or the horizontal orientation 204. For example, if a user of the mobile device 162a is viewing information presented within the display area 210 while the mobile device 162a is oriented in the portrait orientation 202, and then rotates the mobile device 162a into the horizontal orientation 204, the information presented within the display area 210 of the mobile device 162a may be rotated ninety (90) degrees, such that the information (e.g., text, etc.) is presented from left to right across the width 212 of the display area 210 when in the horizontal orientation. However, automatic re-orientation of the information presented within the display area 210 may not result in presentation of all information within the display area 220.

With respect to a grid question, for example, the selectable inputs or controls for answering the question may be presented horizontally (e.g., from left to right across the width 212 of the display area 210 of the mobile respondent device 162a or from left to right across the width 222 of the display area 220 of the non-mobile respondent device 164a). One approach that has been suggested to reduce a likelihood that not all information is presented at the mobile respondent device 162a has been to convert the horizontally displayed selectable inputs of a grid question into a vertical list. Such conversion techniques may cause the mobile respondent to scroll down to see all of the selectable inputs (e.g., scale points), which may bias the data towards selectable inputs that are visible within the display area 210 without scrolling. One or more aspects of the present disclosure provide systems and methods for reducing a likelihood that the mobile respondents will be influenced by such bias, as described in more detail below.

Referring back to FIG. 1, the scoring engine 130 may analyze the communication data 152 to determine the attribute associated with the scale length of the communication. In an aspect, the attribute associated with the scale length of the communication may be associated with a maximum number of scale points (e.g., answer choices in a multiple choice question, selectable inputs in a grid question, etc.) in a single question of the communication. For example, the communication may include several questions with five (5) scale points, several questions with three (3) scale points, and other questions with eight (8) scale points. In such an example, the attribute associated with the scale length of the communication may indicate a maximum scale length of eight (8).

In another aspect, the attribute associated with the scale length of the communication may be associated with an average number of scale points per question for the communication. For example, the communication may include two (2) questions with two (2) scale points, four (4) questions with six (6) scale points, and one (1) question with seven (7) scale points. In such an example, the attribute associated with the scale length of the communication may indicate an average scale length of five (5), indicating each question of the communication, on average, includes five (5) answer choices (e.g., (2+2+6+6+6+6+7)/7=5).

In yet another aspect, the attribute associated with the scale length of the communication may be associated with a range of scale points representative of the communication. For example, the scoring engine 130 may determine the maximum number of scale points for a single question in the communication or the average scale points for the communication, as described above, and then determine whether the maximum number of scale points or the average scale points falls within a first range of scale points (e.g., 0-5 scale points), a second range of scale points (e.g., 6-8 scale points), a third range of scale points (e.g., 9-11 scale points), or a fourth range of scale points (e.g., 12+scale points). Although described using four (4) ranges of scale points, the present disclosure contemplates use of more than or less than four (4) ranges of scale points, and the use of four (4) ranges of scale points is for purposes of illustration, rather than by limitation. Additionally, the exemplary techniques that the scoring engine 130 may use to determine the attribute associated with the communication scale length described above are not intended to be exhaustive or limiting, and other techniques of determining the attribute associated with scale length may be utilized without departing from the scope of the present disclosure.

The attribute associated with the LOI may indicate an average amount of time a respondent (e.g., both mobile and non-mobile respondents) will spend completing the communication. In an aspect, the LOI may be determined based on information included in the communication data 152. For example, the client (e.g., the user of the client device 150) may estimate the LOI and may include the estimated LOI in the communication data 152. In an additional or alternative aspect, the scoring engine 130 may dynamically determine an estimated LOI. For example, the scoring engine 130 may calculate a number of words of text included in the communication (e.g., a number of words in both the questions and the answer choices) and may use an average reading speed of “X” number of words per minute to estimate the LOI.

The average reading speed may be based on historical data (not shown in FIG. 1) indicating an average reading speed of the respondents. In an aspect, the database 124 may store historical LOI information determined by measuring actual amounts of time the respondents spent completing communications using the respondent devices 160. The historical LOI information may indicate whether a particular entry is associated with ah communication completed on one of the mobile respondent devices 162 or on one of the non-mobile respondent devices 164. The historical LOI information may further include average LOI information for portions of communications.

For example, the historical LOI information may include average amounts of time spent answering particular types of communication questions, such as an average amount of time spent answering a grid question having five (5) scale points, an average amount of time answering an open ended question, an average amount of time spent answering a multiple choice question with four (4) answer choices, an average amount of time spent answering a multiple choice question combined with an open ended question, etc. The scoring engine 130 may be configured to dynamically determine the LOI for the communication data 152 based on the historical data (e.g., by predicting an LOI for each questions based on a comparison of the communication to the historical LOI information). Additionally, even when the communication data 152 includes LOI information provided by the client, the scoring engine 130 may compare the LOI information included in the communication data 152 to the historical LOI information to estimate the accuracy of the LOI information. The device 110 may be configured to provide feedback regarding the estimate accuracy of the LOI information to the client, as described in more detail below with reference to the reporting engine 136.

In some aspects, the LOI may be different depending on whether the communication is to be distributed to the respondents at one of the mobile respondent devices 162 or at one of the non-mobile respondent devices 164. For example, responding to communications using the mobile respondent devices takes appreciably longer (e.g., on average twenty five percent (25%) longer) to complete. This result may be influenced by mobile respondents reading slower due to reduced font sizes and/or the smaller display area (e.g., the display area 210 of FIG. 2) on the mobile respondent devices 162 when compared to the non-mobile respondents. Additionally, this result may be influenced by the mobile respondents may performing more manipulation of the visual data (e.g., scrolling, zooming in, zooming out, correcting input errors, etc.) when compared to the non-mobile respondents. Furthermore, the amount of manipulation performed by mobile respondents and/or the reading speed of the mobile respondents may differ between larger or smaller mobile respondent device types (e.g., tablet computing devices vs. smartphones), which increase the complexity of communication design and may be accounted for during the scoring of the communication by the communication engine 130. Thus, in some aspects, the scoring engine 130 may determine the LOI attribute based at least in part on whether the communication is to be distributed to mobile respondents or non-mobile respondents, or even different types of mobile respondent devices, as described in more detail below. Additionally, the scoring of the communication may take one or more of the factors described above into account, as described further below.

The attribute associated with the LOI of the communication may be more important when distributing communication to mobile respondents. For example, mobile respondents may be less patient when it comes to taking longer communications (e.g., communications with LOIs indicating appreciable time will be spent completing the communication) on the mobile respondent devices 162. One or more aspects of the present disclosure provide systems and methods for creating communications having LOI attributes suitable for distribution to mobile respondents, as described in more detail below.

The attribute associated with the wording of questions included in the communication may indicate whether the wording of the questions included in the communication is suitable for presentation at the mobile respondent devices 162. For example, many communications are written without considering differences in the amount of screen real estate (e.g., differences between the size of the display area 210 and the display area 220 of FIG. 2) available at the mobile respondent devices 162 and the non-mobile respondent devices 164. Thus, the words of many communication questions are not chosen judiciously, resulting in communication questions that are overly long and consume more screen real-estate than is necessary. This may introduce communication bias (e.g., bias towards information visible within the display area 210 of FIG. 2 without scrolling), or may cause the respondent to skip the question or become frustrated, potentially corrupting the communication feedback received from the mobile respondents.

In an aspect, the scoring engine 130 may analyze the wording of the questions to identify redundant words, potentially ambiguous phrases, extraneous or unnecessary words, etc. Additionally or alternatively, the scoring engine 130 may classify the communication into one of a plurality of categories. For example, a first category may be associated with communications that include a first percentage of clear and succinct questions, a second category may be associated with communications having a second percentage of clear and succinct questions, and a third category may be associated with communications having a third percentage of clear and succinct questions. In an aspect, the percentages may be distinguished by threshold percentages. For example, communications having a percentage of clear and succinct questions that satisfy a first threshold may be classified in the first category, and communications having a percentage of clear and succinct questions that do not satisfy a second threshold may be classified in the third category. Communications may be classified into the second category when the percentage of clear and succinct questions does not satisfy the first threshold but does satisfy the second threshold.

Although described using three (3) categories, the present disclosure contemplates use of more than or less than three (3) categories, and the use of three (3) categories is for purposes of illustration, rather than by limitation. Additionally, the exemplary techniques that the scoring engine 130 may use to determine the attribute associated with the wording of questions included in the communication described above are not intended to be exhaustive or limiting, and other techniques of determining the attribute associated with the wording of questions included in the communication may be utilized without departing from the scope of the present disclosure. One or more aspects of the present disclosure provide systems and methods for creating communications with clearly and succinctly worded questions and answer choices, and may eliminate or reduce an amount unnecessary and/or redundant words included in communications.

The attribute associated with a number of answer choices for the communication may be associated with a maximum number of answer choices in a single question (e.g., a multiple choice question) of the communication. For example, the communication may include several multiple choice questions with five (5) answer choices, several multiple choice questions with three (3) answer choices, and other multiple choice questions with eight (8) answer choices. In such an example, the attribute associated with the number of answer choices for the communication may indicate a maximum number of answer choices of eight (8).

In another aspect, the attribute associated with the number of answer choices for the communication may indicate an average number of answer choices per multiple choice question for the communication. For example, the communication may include two (2) multiple choice questions with two (2) answer choices, four (4) multiple choice questions with six (6) answer choices, and one (1) multiple choice question with seven (7) answer choices. In such an example, the attribute associated with the number of answer choices for the communication may indicate an average number of answer choices of five (5), indicating each multiple choice question of the communication, on average, includes five (5) answer choices (e.g., (2+2+6+6+6+6+7)/7=5).

In yet another aspect, the attribute associated with the number of answer choices for the communication may be associated with a range of answer choices representative of the communication. For example, the scoring engine 130 may determine the maximum number of answer choices for a single multiple choice question in the communication or the average number of answer choices for the communication, as described above, and then determine whether the maximum number of answer choices or the average number of answer choices falls within a first range of answer choices (e.g., 1-8 answer choices), a second range of answer choices (e.g., 9-15 answer choices), a third range of answer choices (e.g., 16-20 answer choices), or a fourth range of answer choices (e.g., 21+answer choices). Although described using four (4) ranges of answer choices, the present disclosure contemplates use of more than or less than four (4) ranges of answer choices, and the use of four (4) ranges of answer choices is for purposes of illustration, rather than by limitation. Additionally, the exemplary techniques that the scoring engine 130 may use to determine the attribute associated with the number of answer choices described above are not intended to be exhaustive or limiting, and other techniques of determining the attribute associated with the number of answer choices may be utilized without departing from the scope of the present disclosure.

The number of answer choices may cause the mobile respondent to scroll down to see all of the answer choices, which may bias the communication responses received from the mobile respondents towards answer choices that are visible within the display area (e.g., the display area 210 of FIG. 2) without scrolling. For example, on average, approximately seven (7) or eight (8) answer choices may be presented within a display area (e.g., the display area 210 of FIG. 2) of the mobile respondent device 162 (e.g., the mobile respondent device 162a of FIG. 2) when presented as a vertical list (e.g., when the mobile device 162a of FIG. 2 is oriented in the portrait orientation 202 of FIG. 2). Additionally, when all of the answer choices are not visible within the display area (e.g., the display area 210 of FIG. 2) at the same time without scrolling, the LOI of the communication may be increased, as the mobile respondent will need to scroll through the communication to see each of the answer choices. One or more aspects of the present disclosure provide for systems and methods for reducing a likelihood that the mobile respondents will be influenced by such bias, as described in more detail below.

The attribute indicating whether the communication is compatible with the mobile respondent devices 162 may indicate whether the communication utilizes application programming interfaces (APIs) or other technology that is not accessible or executable on the mobile respondent devices 162. For example, approximately ninety eight percent (98%) of the mobile respondent devices 162 do not support files created using Adobe® Flash® platforms. Despite such device limitations, many clients continue to request or create communications that include elements utilizing the Adobe® Flash® platforms. Thus, mobile respondents who are responding to communications using the mobile respondent devices 162 may not be able to answer all of the communication questions (e.g., the communication elements created using the Adobe® Flash® platforms). This may create a frustrating experience for the respondent. Additionally, the communication responses generated using the mobile respondent devices 162 may be incomplete (e.g., due to the presence of the communication elements created using the Adobe® Flash® platforms), and may need to be discarded to avoid corrupting or skewing the communication. One or more aspects of the present disclosure provide for systems and methods for providing communications to mobile respondents while simultaneously eliminating or reducing a likelihood that the communications will become corrupt due to incomplete responses being received from the mobile respondents (e.g., due to the communication including elements that are not compatible with the mobile respondent devices 162).

The attribute associated with utilization of grids may indicate whether the communication utilizes grids. For example, the scoring engine 130 may set a value of the attribute associated with utilization of grids to a first value when the communication includes grid questions, and may set the value of the attribute associated with utilization of grids to a second value when the communication does not include grid questions, where the first value is different from the second value (e.g., the first value indicates grid questions are used in the communication and the second value indicates that grid questions are not used in the communication).

Alternatively or additionally, the attribute associated with utilization of grids may indicate an average complexity of grid questions included in the communication, if any. For example, and referring to FIG. 3, a block diagram illustrating exemplary aspects of a grid question is shown and designated 300. As shown in FIG. 3, the grid question 300 includes a question prompt 310, a first feature prompt 312, a second feature prompt 314, and a third feature prompt 316.

The question prompt 310 may be a question that prompts the respondent or instructs the respondent about how to evaluate each of the feature prompts 312, 314, 316. For example, the question prompt 310 may read “How important are each of the following features to you when using product ‘X’?” Each of the feature prompts 312, 314, 316 may list a particular feature of the product “X.” The respondent may evaluate each of the features indicated by the feature prompts 312, 314, 316 using selectable controls (e.g., radio buttons, check boxes, etc.). The selectable controls may be provided for each of the feature prompts 312, 314, 316, and may include evaluation indicators, such as a first evaluation indicator 320 “Rating 1” and a second rating indicator “Rating N.” The evaluation indicators 320, 322 may indicate whether a particular selectable control indicates a favorable evaluation, an unfavorable evaluation, or an evaluation somewhere in between a favorable evaluation and an unfavorable evaluation.

For example, a first selectable control below the first evaluation indicator 320 may correspond to an unfavorable evaluation and an Nth selectable control below the second evaluation indicator 322 may indicate a favorable evaluation. Thus, a selection of the first selectable control with respect to the first feature prompt 312 may indicate that the first feature of the product “X” is an unfavorable feature of the product “X” to the respondent, and a selection of the Nth selectable control with respect to the first feature prompt 312 may indicate that the first feature of the product “X” is a favorable feature of the product “X” to the respondent. A selection of an intermediate selectable control (e.g., one of the selectable controls between the first selectable control and the Nth selectable control may indicate an intermediate favorability evaluation for the first feature of product “X” by the respondent. For example, selection of the selectable control in the middle may indicate that the first feature of product “X” is neither a favorable, nor a unfavorable feature of the product “X” to the respondent.

Additionally, as shown in FIG. 3, the feature prompts 312, 314, 316 and the corresponding evaluation indicators/selectable controls may be arranged into rows 328, and each row may include a plurality of selectable controls 326. The plurality of selectable controls 326 for a particular row may include a number of selectable controls from 1 to N (e.g., N=7 in FIG. 3). In some aspects, the number of selectable controls for a particular row (e.g., one of the rows 328) of a grid question may include a different number of selectable controls than another particular row of the grid question. Additionally, when the communication includes multiple grid questions, a first grid question may include a same number of rows, a same number of feature prompts, and/or a same number of selectable controls as a second grid question, or may include a different number of rows, a different number of feature prompts, and/or a different number of selectable controls as the second grid question.

Referring back to FIG. 1, the scoring engine 130 may analyze the communication to determine whether the communication includes any grid questions. If the communication includes grid questions, the scoring engine 130 may determine a maximum number of rows (e.g., a maximum number of rows 328 of FIG. 3) included in a single grid question of the communication. For example, the communication may include two (2) grid questions having four (4) rows and three (3) rows, respectively. Thus, the scoring engine 130 may determine that the maximum number of rows included in a grid question of the communication is four (4). The scoring engine 130 may analyze the communication to determine an average number of rows (e.g., an average number of rows 328 of FIG. 3) included in the grid questions of the communication. For example, the communication may include two (2) grid questions having five (5) rows and one grid question having eight (8) rows. Thus, the scoring engine 130 may determine that the average number of rows included in the grid questions of the communication is six (6) (e.g., (5+5+8)/3=6).

Alternatively or additionally, the scoring engine 130 may analyze the grid questions included in the communication to determine a maximum number of selectable controls (e.g., a maximum number of selectable controls 326 of FIG. 3) included in a single grid question of the communication. For example, the communication may include two (2) grid questions having four (4) selectable controls and three (3) selectable controls, respectively. Thus, the scoring engine may determine that the maximum number of selectable controls included in a grid question of the communication is four (4). Additionally or alternatively, the scoring engine 130 may analyze the communication to determine an average number of selectable controls (e.g., an average number of selectable controls 326 of FIG. 3) included in the grid questions of the communication. For example, the communication may include two (2) grid questions having five (5) selectable controls per row and one grid question having eight (8) selectable controls per row. Thus, the scoring engine 130 may determine that the average number of selectable controls included in the grid questions of the communication is six (6) (e.g., (5+5+8)/3=6).

In additional or alternative aspects, the scoring engine 130 may analyze the grid questions of the communication to determine a maximum length, an average length, or other aspects related to feature prompts (e.g., the feature prompts 312, 314, 316 of FIG. 3) of the grid questions included in the communication. Such a determination may be determined similarly to the techniques described above with respect to determining the maximum number of rows/selectable controls and the average number of rows/selectable controls, as described above.

Grid questions may consume substantial amounts of the display area (e.g., the display area 210 of FIG. 2) when presented on the mobile respondent devices 162. Additionally, the selectable controls used to provide the evaluation indications may be very difficult to negotiate when responding to the communication using one of the mobile respondent devices 162. For example, the respondent may need to scroll, zoom in, zoom out, etc., and, due to the smaller display area, it may be more likely that a mobile respondent will inadvertently select an incorrect selectable control. One or more aspects of the present disclosure provide for systems and methods for providing communications including grid questions to mobile respondents while simultaneously eliminating or reducing a likelihood that the communications will become corrupt due to incorrect responses being provided from the mobile respondents, and that may also increase the ease of answering grid questions using the mobile respondent devices 162.

The scoring engine 130 may further analyze the communication to determine the attribute associated with use of rich media (e.g., images). For example, in some instances, use of images may enhance a communication question while, in other instances, use of images may detract from the communication question. To illustrate, use of images may enhance communication questions regarding brand recognition, such as when a question asks the respondent “Which of the following products are you using′?” and several images of products or logos corresponding to different providers of the product may be shown to the respondent. As another example, a question may prompt the respondent to answer a series of open ended questions, such as “In one sentence or less, describe how you feel about each of the following:” and display a series of logos or products. In some instances, use of images may distract the respondent from the prompt of the question, such as when the question or desired response to the question is not related to the image in more than a tangential way, or when the image may potentially bias the respondent's answer. As an example, if an image of a logo of a home improvement retailer was displayed with a question asking the respondent “Do you enjoy working on ‘do it yourself projects’?”, the presence of the logo may bias the respondent to answer yes, even though the question was not directed to the particular home improvement retailer associated with the logo. Thus, the scoring engine 130 may determine whether an image presented in connection with a particular question introduces bias or is extraneous to the particular question.

Additionally or alternatively, the attribute associated with use of rich media may simply indicate the presence of images within the communication. Some demographic groups (e.g., males between the age of 18 and 35) may be more engaged when communications include rich media (e.g., images) than when communications do not include rich media, while other demographic groups (e.g., males between the age 55 and 75) may be less engaged when communications include rich media. Thus, for communications targeting certain demographic groups, the use of rich media may be a benefit or a detriment. One or more aspects of the present disclosure provide for systems and methods for providing communications including rich media to mobile respondents based on demographic information, and/or for reducing a likelihood that use of rich media introduces potential biasing factors or otherwise distracts respondents when responding to the communication.

The attribute associated with use of audio/visual elements in the communication may indicate whether the communication includes video and/or audio content to be streamed to the respondent devices 160. Some mobile respondents, or groups of mobile respondents, may dislike the use of audio/visual elements in communications because viewing such elements may consume a portion of the mobile respondents' mobile data plan. These respondents may skip these types of communication questions, potentially corrupting the communication response pool. Additionally, Some demographic groups (e.g., males between the age of 18 and 35) may be more engaged when communications include audio/visual elements than when communications do not include audio/visual elements, while other demographic groups (e.g., males between the age 55 and 75) may be less engaged when communications include audio/visual elements. Thus, for communications targeting certain demographic groups, the use of audio/visual elements may be a benefit or a detriment. One or more aspects of the present disclosure provide for systems and methods for providing communications including audio/visual elements in connection with communication questions to mobile respondents while simultaneously eliminating or reducing a likelihood that the communications will become corrupt due to incomplete communication responses being received from the mobile respondents.

The attribute associated with the responsive design of the communication may indicate whether the communication has been designed with consideration to how one or more of the various attributes described above affect presentation of the communication at the mobile respondent devices 162. For example, the attribute associated with responsive design may indicate a degree to which the font sizes, question layouts (e.g., vertical lists vs. horizontal scales, etc.), use of images, utilization of display area real estate, overall communication aesthetics, size of input controls, etc. are tailored for presentation at the mobile respondent devices.

In an aspect, the communication data 152 may include information that may be used by the scoring engine 130 when determining the one or more attributes. For example, the communication data 152 may include tag information for each question included in the communication. The tag information for a particular question may indicate a question type (e.g., a grid question, an open ended question, a multiple choice question, an image related question, a question pertaining to audio/visual elements, etc.) for the particular question.

Additionally, the tag information may include other information that may be used by the scoring engine 130 when determining the one or more attributes. For example, tag information indicating that a particular question is a grid question may also include information indicating a number of feature prompts (e.g., a number of feature prompts 312, 314, 316 of FIG. 3) included in the particular question, a number of selectable controls included in each row (e.g., each of the rows 328 of FIG. 3), etc. As another example, the tag information may indicate whether an image presented in connection with the particular question is directly related to the particular question or is provided for aesthetic purposes.

The communication data 152 may also include candidate demographic information indicating a desired demographic group or groups that the client desires to distribute the communication to. For example, the communication data 152 may include candidate demographic information indicating that a particular communication is to be distributed to both the mobile respondent devices 162 and the non-mobile respondent devices 164, or is to be distributed to only the mobile respondent devices 162. It may be desirable in some instances to distribute the communication to only the mobile respondent devices 162, such as when the client desires to receive feedback associated with an event (e.g., visit to a theme park, a museum, a sporting event, etc.) in close temporal proximity to the respondents experiencing the event. In this exemplary context, close temporal proximity may mean within a threshold amount of time after the respondent experienced the event. By targeting the distribution of the communication to the mobile respondent devices 162 in this way, the client may engage the respondents while the event is fresh on the minds of the respondents. This may increase a likelihood that the mobile respondents will complete the communication, and/or may increase a quality of the communication responses received.

In some aspects, the communication data 152 may include information associated with multiple communications. For example, the communication data 152 may include information descriptive of a first communication for distribution to the non-mobile respondent devices 164 and information descriptive of a second communication for distribution to the mobile respondent devices 162 (e.g., an instance of the first communication that has been configured for distribution to, and presentation at the mobile respondent devices 162). In some instances, the scoring engine 130 may only determine the attributes of the second communication. In other instances, the scoring engine 130 may determine the attributes of both the first communication and the second communication (i.e., for purposes of tracking trends in how clients are tailoring communications for distribution to the mobile respondent devices 162 or other purposes).

Based on the one or more attributes of the communication data 152, the scoring engine 130 may generate a communication score for the communication. The communication score may be representative of a suitability of the communication for distribution to and/or presentation at a mobile respondent device (e.g., one of the mobile respondent devices 162). The scoring engine 130 may generate the communication score by applying one or more weighting factors to the one or more attributes. In an aspect, the one or more weighting factors may be stored as weighting factors 126 in the database 124, as shown in FIG. 1.

Each of the one or more weighting factors may correspond to a particular attribute of the one or more attributes determined by the scoring engine 130. The total communication score may correspond to a sum of the application of each of the one or more weighting factors to the corresponding attribute. Stated another way, each attribute may be associated with a particular number of available points, and application of each of the one or more weighting factors to the corresponding attributes may adjust an amount of points to be counted towards the total score for each of the corresponding attributes. Additional aspects of scoring communications using weighting factors are described below and also with reference to FIG. 4.

To illustrate, the scale length attribute for a particular communication may be associated with a first number of available points (e.g., ten (10) points), and application of a weighting factor associated with the scale length attribute may cause the first number of credited points (e.g., points accruing towards the total communication score) to be less than or equal to the first number of available points. To further illustrate, as explained above, communications having less scale points may be preferred to communications having large numbers of scale points. When the attribute associated with the scale length of the communication is categorized into ranges of scale points, as described above, the weighting factor corresponding to the scale length attribute may indicate that, when the attribute associated with the scale length is categorized into the first range of scale points, the first number of credited points should be set equal to the first number of available points (e.g., ten (10) points), and that, when the attribute associated with the scale length is categorized into second range of scale points, the first number of credited points should be set equal to a portion of the first number of available points (e.g., eight (8) points). Additional illustrative aspects of applying weighting factors to communication attributes are described with reference to FIG. 4.

In an aspect, a higher communication score may indicate that the communication is more suitable for distribution to the mobile respondent devices 162, and a lower communication score may indicate that the communication is not suitable, or is less suitable for distribution to the mobile respondent devices 162. In some aspects, the suitability of the communication for distribution to the mobile respondent devices 162 may be indicated by a range of communication scores. For example, a total communication score satisfying a first threshold score (e.g., a total communication score between seven (7) and ten (10) points) may indicate that the communication is suitable for distribution to the mobile respondent devices 162, and the device 110 may distribute the communication to the mobile respondent devices 162 and/or the non-mobile respondent devices 164. Additional features of distributing the communication to the respondent devices 160 are described below with reference to the communication distribution engine 132.

A total communication score satisfying a second threshold score (e.g., a total communication score of between five (5) and seven (7) points) may indicate that the communication is suitable for distribution to the mobile respondent devices 162, but may be improved, which may improve the quality of the feedback received from the respondents and may also increase a number of mobile respondents that complete the communication. In response to detecting the total communication score is satisfies the second threshold score, the scoring engine 130 may cause the device 110 to generate and provide feedback (e.g., a scoring report) to the client device 150. The scoring report may include recommendations for improving the total communication score. Additional features of generating scoring reports and communication recommendations are described below with reference to the reporting engine 136.

A total communication score failing to satisfy the first and second threshold scores (e.g., a total communication score of below five (5) points) may indicate that the communication is not suitable for distribution to the mobile respondent devices 162. In such instances, the device 110 may be configured to refrain from distributing the communication to the mobile respondent devices 162. Depending on the configuration of the device 110, communications having total communication scores that fail to satisfy the first threshold score, but that satisfy the second threshold score, may or may not be distributed to the non-mobile respondent devices 164.

In an aspect, the one or more weighting factors include one or more deterministic weighting factors. A deterministic weighting factor may be a weighting factor that effects the total communication score irrespective of other weighting factors and their application to other attributes. For example, as explained above, almost all of the mobile respondent devices 162 do not support communication elements utilizing Adobe® Flash® platforms. In an aspect, a first deterministic weighting factor may be associated with the attribute indicating whether the communication is compatible with the mobile respondent devices 162 (e.g., does the communication include communication elements utilizing Adobe® Flash® platforms). The scoring engine 130 may be configured to apply the first deterministic weighting factor to the corresponding attribute (e.g., the attribute indicating whether the communication is compatible with the mobile respondent devices 162) and to determine whether the corresponding attribute satisfy the first deterministic weighting factor. The attribute may satisfy the first deterministic weighting factor when the communication is compatible with the mobile respondent devices 162 (e.g., does not include communication elements utilizing Adobe® Flash® platforms), and may not satisfy the first weighting factor when the communication is not compatible with the mobile respondent devices 162.

The scoring engine 130 may modify the total communication score when the corresponding attribute does not satisfy the first deterministic weighting factor, and may refrain from modifying the total communication score when the corresponding attribute satisfies the first deterministic weighting factor. For example, when the attribute satisfies the first weighting factor, the total communication score may be unchanged. However, when the attribute fails to satisfy the first weighting factor, the total communication score may be reduced to zero (0), causing the total communication score to indicate that the communication is not suitable for distribution to and/or presentation at the mobile respondent devices 162.

In some aspects, the scoring engine 130 may be configured to allocate points towards the total communication score when the attribute satisfies the first deterministic weighting factor, as opposed to refraining from modifying the total communication score. For example, when the attribute satisfies the first deterministic weighting factor, the total communication score may be increased by a particular number of points (e.g., ten (10) points).

Additionally, other attributes that may have corresponding deterministic weighting factors may include the scale length attribute (e.g., communications including excessively high numbers of scale points), the grids attribute (e.g., communications includes many grid questions with large numbers of selectable controls or rows that require lots of scrolling), the open ended questions attribute (e.g., communications including large numbers of open ended questions that may be time consuming to answer using the mobile respondent devices 162), or other attributes.

In some aspects, an attribute may be associated with both a deterministic weighting factor and a non-deterministic weighting factor. For example, the grids attribute may be associated with a non-deterministic weighting factor that provides different weighted point values depending on different characteristics of the use of grid questions in the communication, and may also be associated with a deterministic weighting factor that may be selectively applied by the scoring engine 130. The deterministic weighting factor may override the non-deterministic weighting factor (e.g., when the number of grid questions included in the communication exceeds a threshold number of grid questions, when the average number of selectable controls for the grid questions of the communication exceeds a threshold number of selectable controls, etc.). By associating an attribute with both a deterministic weighting factor and a non-deterministic weighting factor, communications including a small number of a particular undesirable aspects of an attribute, such as a few grid questions with large numbers of selectable controls, may still be determined suitable for distribution to, and presentation at the mobile respondent devices 162, assuming the points accrued to the total communication score by the other attributes and the corresponding weighting factors satisfies a threshold total communication score, as described above, while communications that include a large number of undesirable aspects of the attribute may cause the communication to be determined unsuitable for distribution to, and presentation at the mobile respondent devices 162 (e.g., by overriding the score using the deterministic weighting factor).

The weighting factors and attributes utilized by the scoring engine 130 may each provide an indication of the ability of the respondent to effectively and painlessly complete the communication using the mobile respondent devices 162, which has significantly less display area than the non-mobile respondent devices 164. Additionally, the weighting factors and attributes utilized by the scoring engine 130 may each provide an indication of the ability of the respondent to navigate the communication using a finger, whereas the non-mobile respondents may navigate the communication using a mouse that provides much more intuitive and precise navigation control.

In an aspect, sets of weighting factors may be determined based on demographic information. For example, the weighting of particular attributes may be different for different demographic groups, where a particular attribute may be weighted more heavily for a first demographic group than for a second demographic group. The different weightings may make it more difficult, or easier for a communication to receive a total communication score that indicates the communication is suitable for distribution to the mobile respondent devices 162 when the demographic information indicates the first demographic group than when the demographic information indicates the second demographic group.

For example, the LOI attribute may be weighted differently for the first demographic group (e.g., males between the ages of 18 and 24) relative the second demographic group (e.g., females between the ages of 18 and 24). The different weightings may be determined empirically based on historical communication response information that indicates that the first demographic group is less likely to complete communications having LOI attributes indicating an average communication completion time that exceeds a first threshold amount of time (e.g., ten (10) minutes), and that indicates that the second demographic group routinely completes communications having LOI attributes indicating an average communication completion time that exceeds a second threshold amount of time (e.g., fifteen (15) minutes). The historical communication response information may be stored at the database 124 of the device 110.

In another aspect, sets of weighting factors may be determined based on different features of the mobile respondent devices 162. For example, the mobile respondent devices 162 may include mobile devices of a first mobile device type (e.g., a smartphone) and mobile devices of a second mobile device type (e.g., a tablet computing device). The first mobile device type and the second mobile device type may have features (e.g., sizes of display areas, input devices/controls, form factors, screen resolutions, wireless communication capabilities, etc.) that are different. To illustrate, mobile devices associated with the first mobile device type may have a smaller display area than mobile devices associated with the second mobile device type. Thus, the weighting of particular attributes may be different for the two mobile device types. The different weightings may make it more difficult, or easier for a communication to receive a total communication score that indicates the communication is suitable for distribution to particular mobile devices (e.g., mobile devices of the first mobile device type or the second mobile device type) included in the mobile respondent devices 162.

For example, the grids attribute may be weighted differently for the first mobile device type and the second mobile device type. The different weightings may be configured to account for differences in a size of the display area of the different mobile device types. Thus, use of grid questions including a number of feature prompts (e.g., a maximum number of feature prompts, an average number of feature prompts, etc.) or a number of selectable controls (e.g., a maximum number of selectable controls, an average number of selectable controls, etc.) exceeding a first threshold may cause a first number of communication score points to be accrued by the total communication score for mobile devices of the first mobile device type, and may cause a second number of communication score points to be accrued by the total communication score for mobile devices of the second mobile device type, where the second number of points is greater than the first number of points. This may provide an indication that use of such grid questions affects the presentation of the communication at the mobile devices of the first mobile device type more than the presentation of the communication at the mobile devices of the second mobile device type due to the differences in the display area of the different mobile device types. Thus, the different sets of weighting factors may cause the communication score to indicate that the communication is suitable for distribution to a subset of the mobile respondent devices 162 (e.g., a set of mobile respondent devices 162 associated with the second device type), and to indicate that the communication is not suitable for distribution to other mobile respondent devices 162 (e.g., a set of mobile respondent devices 162 associated with the first device type). This may enable targeting of communications to selected mobile respondent devices 162 (e.g., the set of mobile respondent devices 162 associated with the second device type) that are suitable for presentation of the communication even when the communication is not suitable for presentation at all of the mobile respondent devices 162 (e.g., the set of mobile respondent devices 162 associated with the first device type).

Thus, in some aspects, when determining the communication score based on the communication data 152, the scoring engine 130 may identify a first set of weighting factors and a second set of weighting factors to be used when scoring the communication. The first set of weighting factors may be associated with the first demographic group or the first mobile device type, and the second set of weighting factors may be associated with the second demographic group or the second mobile device type. The scoring engine 130 may apply the first set of weighting factors to the one or more attributes to generate a first communication score (e.g., a communication score indicating whether the communication is suitable for presentation to mobile respondents associated with the first demographic group, or for presentation at mobile respondent devices 162 associated with the first mobile device type), and may apply the second set of weighting factors to the one or more attributes to generate a second communication score (e.g., a communication score indicating whether the communication is suitable for presentation to mobile respondents associated with the second demographic group, or for presentation at mobile respondent devices 162 associated with the second mobile device type). The communication score information generated by the scoring engine 130 may include information associated with the first communication score and the second communication score.

In an additional or alternative aspect, different sets of attributes may be sued by the scoring engine 130 to score communications. For example, a first set of attributes may be selected by the scoring engine 130 based on first demographic information (e.g., demographic information associated with a first demographic group) and a second set of attributes may be selected by the scoring engine 130 based on second demographic information (e.g., demographic information associated with a second demographic group). The first and second sets of attributes may include mutually exclusive attributes (e.g., the first set of attributes does not include any attributes included in the second set of attributes), or the first set of attributes may include one or more attributes in common with the second set of attributes and include at least one attribute that is not included in the second set of attributes. The use of different sets of attributes to score the communication may help identify communications that are more suitable for distribution to particular demographic groups, which may increase a likelihood that the particular demographic groups would complete the communication. Additionally, the use of different sets of attributes to score the communication may help determine whether the communication could be modified to appeal to one or more target demographic groups for which the communication score indicates the communication, in its present form, is not suitable. Furthermore, when the different sets of attributes include common attributes, the common attributes may be associated with different weighing factors.

In some instances, the different sets of attributes may be determined based on criteria other than demographic information, such as a mobile device type. For example, the scoring engine may score the communication using a first set of attributes and/or a first set of weighting factors selected or configured for a first device type (e.g., a smartphone), and may score the communication using a second set of attributes and/or a second set of weighting factors selected or configured for a second device type (e.g., a tablet computing device). The first and second sets of attributes may include mutually exclusive attributes (e.g., the first set of attributes does not include any attributes included in the second set of attributes), or the first set of attributes may include one or more attributes in common with the second set of attributes and include at least one attribute that is not included in the second set of attributes. The use of different sets of attributes to score the communication may help identify communications that are more suitable for distribution to particular types of mobile respondent devices, which may increase a likelihood that the particular mobile respondents would complete the communication. Additionally, when the different sets of attributes include common attributes, the common attributes may be associated with different weighing factors.

The reporting engine 136 may be configured to generate a scoring report based on the analysis of the communication by the scoring engine 130 and the communication score generated by the scoring engine 130. The scoring report may include information descriptive of a set of attributes that reduced the communication score. For example, as explained above, each attribute may be associated with a particular number of available points, and application of each of the one or more weighting factors to the corresponding attributes by the scoring engine 130 may adjust an amount of points to be counted towards the total score for each of the corresponding attributes. Attributes for which the application of the corresponding weighting factors reduced the amount of points to be counted may be indicated in the set of attributes that reduced the communication score.

To illustrate, assume that each attribute is associated with ten (10) available points. The set of attributes that reduced the communication score may include information associated with attributes attributing less than a threshold amount of available points (e.g., seven (7) points) after application of the weighting factors by the scoring engine. In some aspects, the information descriptive of the set of attributes that reduced the communication score may include information associated with each attribute that failed to contribute the maximum number of available points (e.g., ten (10) points). In additional or alternative aspects, the information descriptive of the set of attributes that reduced the communication score may include information associated with any attributes that caused the communication score to indicate that the communication is not suitable for presentation at the mobile respondent devices 162 (e.g., based on a deterministic weighting factor). In an aspect, the scoring report may be generated in response to a determination that the communication score does not satisfy a threshold score (e.g., a communication score indicating that the communication is suitable for presentation at the mobile respondent devices 162). In an additional or alternative aspect, the scoring report may be generated in response to a determination that the communication score indicates the communication, although suitable for presentation at the mobile respondent devices 162, may be improved, thereby increasing a likelihood that the mobile respondents will complete the communication using the mobile respondent devices 162.

The scoring report may include recommendations for improving the communication score of the communication. For example, the reporting engine 136 may determine one or more recommendations for improving a subsequent scoring of the communication. The one or more recommendations may be determined based on the set of attributes that reduced the communication score below the threshold score (e.g., the communication score indicating that the communication is suitable for presentation at the mobile respondent devices 162). The one or more recommendations for improving the subsequent scoring of the communication may be configured to cause the subsequent scoring of the communication to satisfy the threshold score.

As an example, the attribute indicating whether the communication is compatible with the mobile respondent devices 162 (e.g., whether the communication include communication elements utilizing Adobe® Flash® platforms) may cause the communication score to fall below the threshold score (e.g., based on a corresponding deterministic weighting factor). The scoring report may indicate that, despite all other attributes (e.g., the grids attribute, the LOT attribute, the scale length attribute, etc.) indicating that the communication is suitable for presentation, the inclusion of communication elements utilizing Adobe® Flash® platforms renders the communication unsuitable for distribution to the mobile respondent devices 162. The scoring report may further include a recommendation indicating that reprogramming of the communication to not include communication elements utilizing Adobe® Flash® platforms would cause the communication score to indicate that the communication is suitable for distribution to the mobile respondent devices 162.

As another example, the communication score may fall below the threshold score when multiple attributes, in conjunction with the application of the corresponding weighting factors, indicates that the communication would not perform well on the mobile respondent devices 162. To illustrate, the scale length attribute and the grids attribute indicate that the communication includes a large number of grids questions with many rows and many selectable controls. The scaled score for these attributes, as determined by the application of the corresponding weighting factors, may reduce the total communication score to below the threshold score. The scoring report may indicate a classification of the scale length attribute (e.g., a particular range of scale points associated with the scale length attribute) or other information associated with the analysis of the scale length attribute by the scoring engine 130, and may also indicate information associated with the evaluation of the grids attribute based on the analysis by the scoring engine 130. The scoring report may include one or more recommendations for improving the subsequent scoring of the communication, such as by reducing an average number of scale points, reducing a number of selectable controls used in grid questions, or may suggest reconfiguring the selectable controls from radio buttons to a vertical list, a dropdown menu, a numeric value entry (e.g., using an input device of the mobile respondent devices 162) in a text box, or another recommendation.

Other exemplary recommendations that may be included in the scoring report based on particular weighted attribute scores may include recommendations that open ended questions should be tailored to mobile respondents (e.g., not require a paragraph response), and limiting the number of multiple choice questions including an answer choice of “other” and requesting explanation of the meaning of other (e.g., by inputting text at the mobile respondent devices 162). For the LOI attribute, the recommendations may suggest limiting the LOI of the communication to under a first threshold amount of time (e.g., ten (10) minutes). For communications having scores indicating the communication is suitable for presentation at the mobile respondent devices 162, but that may be improved, the recommendations included in the scoring report may suggest limiting the LOI of the communication to an amount of time between the first threshold amount of time and a second threshold amount of time (e.g., fifteen (15) minutes). If a communication score fails to satisfy the threshold score based on the LOI attribute and a corresponding deterministic attribute (e.g., communications having LOI attributes indicating an LOI in excess of twenty five (25) minutes), the scoring report may indicate that the communication cannot be distributed to the mobile respondent devices due to the communication's LOI attribute.

The scoring report may also include recommendations for organizing answer choices for multiple choice questions. For example, the scoring report may recommend organizing a list (e.g., as brand list) alphabetically to make navigation of the list easier for the mobile respondents (and potentially the non-mobile respondents). In some instances, the recommendation may include suggestions for rotating or randomizing the answer choices. Such recommendations may also be applicable for grid questions as well.

In an aspect, the scoring report may include predictions related to a potential subsequent scoring of the communication based on the recommendations included in the scoring report. For example, the scoring report may indicate that, although the initial scoring of the communication by the scoring engine 130 indicated the communication is not suitable for distribution to the mobile respondent devices 162, adoption of certain recommendations included in the scoring report is predicted to cause the subsequent scoring of the communication by the scoring engine 130 to indicate that the communication is suitable for distribution to the mobile respondent devices 162.

In some aspects, the scoring report may include predicted communication points gained for each of the recommendations. For example, the scoring report may indicate that adoption of a recommendation associated with a first attribute is predicted to increase the total communication score by a first number of points, and that adoption of a recommendation associated with a second attribute is predicted to increase the total communication score by a second number of points. The scoring report may indicate the threshold score, enabling the client to determine which attributes to reconfigure in order to satisfy the threshold score. Additionally, by including the predicted subsequent score if each of the recommendations is adopted, the client may be able to reconfigure some attributes of the communication while leaving other attributes as is. This may be beneficial from a programming standpoint as some attributes may be more difficult or time consuming to reprogram than other attributes.

In an additional or alternative aspect, the scoring report may include estimated communication response information representative of a predicted number of communications that will be completed if the communication is distributed to the mobile respondent devices 162. For example, when the communication score indicates that the communication is suitable for distribution to the mobile respondent devices 162, but may be improved based on the recommendations included in the scoring report, the reporting engine may estimate, based on historical communication response data, a number of responses predicted to be completed by the mobile respondents if the communication is distributed as is, and may estimate, based on the historical response data, an increased number of responses predicted to be completed by the mobile respondents if the communication is reconfigured according to one or more of the recommendations included in the scoring report. This information may enable the client to determine whether a sample size of responses predicted to be received if the communication is distributed as is would be satisfactory, or whether the client desires to reconfigure one or more of the attributes based on one or more of the recommendations included in the scoring report to induce a larger sample size of responses.

The estimated communication response information may also include estimates regarding a number of communication responses predicted to be completed by different demographic groups, and may indicate, for each of the different demographic groups, predicted increases in the number of completed responses if one or more of the recommendations included in the scoring report are adopted. This information may enable the client to determine whether a sample size of responses predicted to be received from one or more target demographic groups if the communication is distributed as is would be satisfactory, or whether the client desires to reconfigure one or more of the attributes based on one or more of the recommendations included in the scoring report to induce a larger sample size of responses from the one or more target demographic groups.

The reporting engine 136, in response to generating the scoring report, may initiate transmission (e.g., using the communication interface 114) of the scoring report to the client device 150 via the network 140 as a scoring report 172, as shown in FIG. 1. The client may receive or view the scoring report 172 at the client device 150, and may elect to reconfigure the communication based on the recommendations included in the scoring report 172. The client may transmit updated communication data (not shown in FIG. 1) descriptive of the reconfigured communication to the device 110 via the network 140. In response to receiving the updated communication data, the device may store the updated communication data at the database 124. The updated communication data may be stored in association with an entry in the communication data 128 corresponding to the communication data 152 or may be stored as a new entry in the communication data 128. Additionally, the scoring engine 130 may score the updated communication based on the updated communication data to determine an updated score for the communication, as described above. In some instances, the client may elect not to reconfigure the communication, such as when the communication score indicates that the communication is suitable for distribution to the mobile respondent devices 162, but may be improved based on the recommendations included in the scoring report.

The communication modification engine 138 may be configured to automatically reconfigure or otherwise modify the communication based on the communication score generated by the scoring engine 130, based on the recommendations generated reporting engine 136, or a combination of the communication score and the recommendations. For example, after the communication is scored, information associated with the communication score may be provided from the scoring engine 130 to the communication modification engine 138. The information associated with the communication score may indicate the total score of the communication and may further indicate, for each attribute identified or otherwise accounted for by the scoring engine 130, a total number points accrued towards the total score of the communication (e.g., based on application of a weighting factor to the attribute) and a number of possible points that could have been accrued (e.g., based on the application of the weighting factor to the attribute).

To illustrate, a communication may be determined to have a first total score by the scoring engine 130. The information associated with the communication score may indicate the first total score, and may indicate that a first number of points of the total score were accrued based on application of a first weighting factor to a first attribute of the communication, and that a second number of points of the total score were accrued based on application of a second weighting factor to the second attribute of the communication, wherein the first total score is equal to a sum of the first number of points and the second number of points. The communication modification engine 138 may determine whether the first number of points satisfies a first threshold number of points. If the first number of points satisfies the first threshold number of points, the communication modification engine 138 may determine that the first attribute of the communication is configured for presentation at the mobile respondent devices 162, and that no modification of the communication is necessary. If the first number of points does not satisfy the first threshold number of points, the communication modification engine 138 may determine that the first attribute of the communication is not configured for presentation at the mobile respondent devices 162, and that no modification of the communication is necessary. The communication modification engine 138 may make a similar determination based on the second number of points and a second threshold score to determine whether the second attribute is configured for presentation at the mobile respondent devices 162. In response to a determination that the first number of points, the second number of points, or both fail to satisfy the first threshold number of points and second threshold number of points, respectively, the communication modification engine 138 may modify one or more aspects of the communication.

For example, assume the communication modification engine 138 may modify the open ended questions included in the communication to include an instruction to limit the response to one (1) or two (2) sentences. In an aspect, the modification may only affect the communication when distributed to the mobile respondent devices 162 (e.g., the instruction may not be included in the communication when the communication is distributed to the non-mobile respondent devices 164). By instructing the mobile respondents to limit the answers to open ended questions to one (1) or two (2) sentences, the mobile respondents may be more likely to answer the open ended questions, since they may feel like longer responses are desired without such an instruction. As explained above, the length of the answers to open ended questions is not an indication of the quality of answers. Thus, a few sentences is likely sufficient to receive meaningful feedback from most open ended questions.

As another example, the communication modification engine 138 may reconfigure the arrangement of scale points in a grid question from a horizontal arrangement to a vertical arrangement. This may enable all of the scale points to be visible within the display area of the mobile respondent devices 162 without scrolling. In some aspects, the communication modification engine 138 may reconfigure the scale points into a dropdown list as opposed to multiple radio buttons, check boxes, etc. This may make selection of a particular scale point easier when responding to the communication using the mobile respondent devices 162.

As yet another example, the communication modification engine 138 may automatically sort and/or rearrange communication elements, such as answers to multiple choice questions, into alphabetical order. To illustrate, a multiple choice question may list a plurality of brands of a product and ask the respondent to select their favorite brand. When the communication data 152 is received, the listing of the plurality of brands may not be in alphabetical order. The communication modification engine 138 may rearrange the listing of the plurality of brands to be in alphabetical order, which may make selection of the particular brand more intuitive for the mobile respondents. In some aspects, the communication modification engine 138 may make multiple modifications to a single attribute of the communication, such as to reconfigure the listing of brands into a dropdown list including the brands listed in alphabetical order. This may make selection of the desired answer easier for the mobile respondents.

As yet another example, the communication modification engine 138 may remove images from the communication when the images are extraneous (e.g., for aesthetic purposes). The communication modification engine 138 may determine that the images are extraneous based on the tag information included in the communication data 152, as described above with respect to the scoring engine 130. Alternatively, the communication modification engine 138 may reduce a size of the extraneous images, which may lessen the chance that the extraneous images introduce bias into the communication.

The communication modification engine 138 may be configured with rules for changing the wording of questions. For example, the communication modification engine 138 may include rules for identifying and removing redundant words or phrases, and/or replacing ambiguous terms or phrases. The communication modification engine 138 may also be configured to change a font, a font size, or a font color of the text included the communication, such as to make the communication more readable when presented at the mobile respondent devices 162.

The modifications to the communication made by the communication modification engine 138 may be configured to cause a subsequent scoring of the communication to indicate the communication is suitable for distribution to the mobile respondent devices 162, although additional modifications and changes to the communication may be made to increase the communication score even more. In an aspect, the communication modification engine 138 may dynamically generate a second instance of the communication, or a proof of the communication, that includes the modifications, and may provide the second instance of the communication (or the proof) to the reporting engine 136. The reporting engine 136 may provide the second instance of the communication (or the proof) to the client device 150 along with the scoring report 172. The client may access the second instance of the communication using the client device 150 and may approve the modifications to the communication and/or authorize distribution of the second instance of the communication. In an aspect, the communication modification module 138 may be incorporated with the client device 150 and may automatically modify the communication, as described above, in response to detecting receipt of the scoring report 172.

In an aspect, the modifications to the communication may be made iteratively in any or all of the ways described above and, after each iteration or modification, a determination may be made as to whether the score has improved, stayed the same, or has been reduced. Modifications that cause the score to be reduced may be rolled back to a previous state of the communication, and other modifications may subsequently be made. In this way, the score may be increased or maximized.

The modifications described above have been provided for purposes of illustration rather than limitation, and other types of modifications, not described in detail herein for conciseness of the present disclosure may be performed by the communication modification engine 138. By modifying communications using the communication modification engine 138, whether at the device 110 or at the client device 150, the compatibility of communications with the mobile respondent devices 162 may be improved and the accuracy of the data collected may be increased. Additionally, the modifications may make the communications more easily navigable when presented at the mobile respondent devices 162.

The communication distribution engine 132 may be configured to distribute communications to the respondent devices 160. The communication distribution engine 132 may be configured to determine distribution information for the communication based at least in part on the communication score. The distribution information may identify a set of respondents of the plurality of respondents that may receive the communication. For example, in response to a determination that the communication score satisfies the threshold score, the communication distribution engine 132 may determine distribution information that identifies the set of respondents that may receive the communication as all respondents (e.g., both the mobile respondents using the mobile respondent devices 162 and the non-mobile respondents using the non-mobile respondent devices 164). The communication distribution engine 132 may authorize distribution of the communication to the set of respondents identified by the distribution information, and may initiate transmission (e.g., using the communication interface 114) of the communication to the set of respondents via the network 140 as a communication 170, as shown in FIG. 1.

In an aspect, the communication distribution engine 132 may determine the distribution information based at least in part on demographic information included in the communication data 152 (or the updated communication data). For example, the database 124 may store information associated with one or more respondent profiles (not shown in FIG. 1). The respondent profiles may include information indicating demographic information for each of the respondents. The demographic information may include information indicating an age of the respondents or an age range of the respondents, information identifying one or more respondent devices 160 used by each of the respondents to answer communications (e.g., the communication 170), information indicating a device type (e.g., the first mobile device type, the second mobile device type, or a non-mobile device type) for each of the one or more respondent devices 160, contact information (e.g., an email address, a telephone number, etc.) that may be used to contact each of the respondents or to provide the communication 170 to the respondents, information indicated areas of interest, purchasing habits, etc. for each of the respondents, and other information that may be utilized to target communications to particular respondents based on candidate demographic information (e.g., demographic information included in the communication data 152).

As shown in FIG. 1, the respondent devices 160 (or the set of respondent devices authorized to receive the communication 170 by the communication distribution engine 132), may receive the communication 170 via the network 140. In an aspect, the communication 170 may be received at the respondent devices 160 via an email message including a web-link to a URL of a web page where the communication is accessible. In an additional or alternative aspect, the communication 170 may be received at the respondent devices 160 via an SMS message including the web-link to the URL of the web page where the communication is accessible. Other techniques for distributing the communication 170 to the respondent devices 160 may be used by the device 110. Thus, the exemplary techniques for distributing the communication 170 to the respondent devices 160 described herein are provided for purposes of illustration, rather than limitation.

As the respondents complete the communication using their respective respondent devices 160, the responses to the questions of the communication may be provided to the device 110 as communication feedback 166. In some aspects, the communication feedback 166 may be provided to the client device 150 in addition to, or in the alternative to providing the communication feedback 166 to the device 110. The feedback engine 134 may process the communication feedback to generate information representative of the responses to the questions of the communication. The information may be generated based on the communication feedback 166. In an aspect, the reporting engine 136 may generate a communication report 174 that includes information associated with the analysis of the communication feedback 166 by the feedback engine 134. For example, the feedback engine 134 may analyze the communication feedback 166 based on demographic information (e.g., a comparison of responses to the questions of the communication responses received from respondents associated with different demographic groups).

In an aspect, the communication feedback engine 134 may determine performance metrics associated with a relationship between the communication feedback 166 and the communication score determined by the scoring engine 130. The performance metrics may indicate whether respondents using non-mobile respondent devices answered particular questions with greater frequency than mobile respondents, or whether a distribution of responses to one or more questions of the communication were distributed differently (e.g. potentially indicated bias towards answers displayed within the display area without scrolling, etc.) between the communications completed using the mobile respondent devices 162 and the non-mobile respondent devices 164.

Additionally, the performance metrics may identify trends and/or relationships between particular demographic groups and particular attributes of communications. The feedback engine 132 may determine whether to modify at least one weighting factor of the one or more weighting factors based on the performance metrics. Modification of the at least one weighting factor may include increasing an amount of weight given to the at least one weighting factor, reducing an amount of weight given to the at least one weighting factor, eliminating the at least one weighting factor from a set of weighting factors (e.g., a set of weighting factors associated with a particular demographic group, a set of weighting factors associated with a particular mobile device type, etc.), introducing a new weighting factor (e.g., a new deterministic weighting factor, a new non-deterministic weighting factor, or a combination thereof), combining two or more weighting factors, or a combination thereof.

The modification of the weighting factors 126 may cause the scoring engine 130 to more accurately identify communications suitable for distribution to the mobile respondent devices 162. Additionally, the modification of the weighting factors 126 and/or grouping of the weighting factors into sets of weighting factors associated with particular demographic groups may enable the device 110 to target communications to particular demographic groups more effectively, resulting in an increased likelihood that the communication feedback 166 will provide meaningful information to the client.

In an aspect, the scoring engine 130, the communication distribution engine 132, the feedback engine 134, and the reporting engine 136 may be implemented as instructions (e.g., the instructions 122) executable by the processor 112. In an additional or alternative aspect, one or more of the scoring engine 130, the communication distribution engine 132, the feedback engine 134, and the reporting engine 136 may be implemented as an integrated circuit, a microchip, an ASIC, an FPGA device, a controller, a microcontroller, a state machine, or another hardware device configured to perform the operations of one or more of the respective engines 130, 132, 134, 136. In other additional or alternative aspects, the scoring engine 130 may determine the communication score based on inputs received at the device 110 using an input device (not shown in FIG. 1). For example, an employee of the entity operating the device may provide inputs indicating the one or more attributes of the communication (e.g., a classification of the scale length into a particular range of scale points, etc.) to an application configured to generate the communication score, the scoring report, etc. The application may be stored as the instructions 122, and may be configured to perform operations of the other respective engines (e.g., the communication distribution engine 132, the feedback engine 134, and the reporting engine 136) described above.

The system 100, and in particular the device 110, may enable the entity operating the device 110 to increase stickiness of the respondents enrolled with the entity only distributing communications to mobile respondents that have been designed with the mobile respondents needs in mind, as indicated by the communication scores. Additionally, communications distributed according to the operations of the device 110 described above may provide more meaningful feedback to the client (e.g., an entity operating the client device 150) because the mobile respondents may be more likely to complete a communication distributed according to the method 500.

Referring to FIG. 4, a block diagram illustrating exemplary aspects of identifying attributes of a communication and applying weighting factors to the attributes to determine a communication score is shown and designated 400. As shown in FIG. 4, the block diagram 400 includes a set of attributes 402 and a corresponding set of weighting factors 404. As explained above with reference to FIG. 1, the attributes 402 may include a scale length attribute 410, a length of interview (LOI) attribute 420, an open ends attribute 430, a question wording attribute 440, a number of answer choices attribute 450, a communication compatibility attribute 460, a use of grids attribute 470, a use of rich media attribute 480, a use of audio/video streaming attribute 490, and a responsive design attribute 495.

Each of the attributes 402 may be identified by a scoring engine (e.g., the scoring engine 130 of FIG. 1) based on communication data (e.g., the communication data 152 of FIG. 1) that includes information descriptive of a communication. In an aspect, the information may include tag information, as described with reference to FIG. 1. In another aspect, the information may include text, and the scoring engine may be configured to parse the text to identify the attributes 402.

In the example illustrated in FIG. 4, one or more of the attributes 402 may be associated with a maximum (e.g., a maximum number of scale points or a maximum number of answer choices in a single question, etc.), as described with reference to FIG. 1. For example, the scale length attribute 410 may indicate a maximum number of scale points used in a single question of the communication, and the number of answer choices attribute 450 may indicate a maximum number of multiple choice answers provided in connection with a single question of the communication.

Other attributes may not be associated with maximum numbers of a particular attribute. For example, the open ends attribute 430 may indicate a total number of open ended questions included in the communication. In some aspects, this may include accounting for multiple choice questions with an “other-specify” type question.

The scale length attribute 410 may correspond to a number of scale points (e.g., in a grid question) or other communication information that may be presented within the display area at a single time, as described with reference to FIG. 1, and may be associated with a first category 412 (e.g., a maximum of 5 scale), a second category 414 (e.g., a maximum of 7 scale points), a third category 416 (e.g., a maximum of 8 scale points), and a fourth category 418 (e.g., a maximum of 100 scale points). As explained above with respect to FIG. 1, the scoring engine may determine or otherwise associate the scale length attribute 410 with a particular one of the categories 412, 414, 416, 418.

As shown in FIG. 4, each of the categories 412, 414, 416, 418 may correspond to a particular weighting factor having a particular weight. For example, the first category 412 may correspond to a first weighting factor having a weight of ten (10) points, the second category 414 may correspond to a second weighting factor having a weight of eight (8) points, the third category 416 may correspond to a third weighting factor having a weight of five (5) points, and the fourth category 418 may correspond to a fourth weighting factor having a weight of zero (0) points. When the scale length attribute 410 is classified as within the first category 412, the scale length attribute 410 may contribute a total of ten (10) points to the communication score. When the scale length attribute 410 is classified as within the second category 414, the scale length attribute 410 may contribute a total of eight (8) points to the communication score. When the scale length attribute 410 is classified as within the third category 416, the scale length attribute 410 may contribute a total of five (5) points to the communication score. When the scale length attribute 410 is classified as within the fourth category 418, the scale length attribute 410 may contribute zero (0) points to the communication score. Thus, depending on the classification of the scale length attribute 410 by the scoring engine, the scale length attribute 410 may contribute anywhere from ten (10) to zero (0) points to the total communication score.

The LOI attribute 420 may correspond to an average amount of time a respondent (e.g., both mobile and non-mobile respondents) will spend completing the communication, and may be associated with a first category 421 (e.g., an estimated communication completion time between one (1) and nine (9) minutes), a second category 423 (e.g., an estimated communication completion time between ten (10) and fourteen (14) minutes), a third category 425 (e.g., an estimated communication completion time between fifteen (15) and nineteen (19) minutes), a fourth category 427 (an estimated communication completion time between twenty (20) and twenty four (24) minutes), and a fifth category 429 (e.g., an estimated communication completion time greater than twenty five (25) minutes). As explained above with respect to FIG. 1, the scoring engine may determine or otherwise associate the LOI attribute 420 with a particular one of the categories 421, 423, 425, 427, 429.

As shown in FIG. 4, each of the categories 421, 423, 425, 427, 429 may correspond to a particular weighting factor having a particular weight. For example, the first category 421 may correspond to a first weighting factor having a weight of ten (10) points, the second category 423 may correspond to a second weighting factor having a weight of eight (8) points, the third category 425 may correspond to a third weighting factor having a weight of five (5) points, the fourth category 427 may correspond to a fourth weighting factor having a weight of two (2) points, and the fifth category 429 may correspond to a fifth weighting factor having a weight of zero (0) points. When the LOI attribute 420 is classified as within the first category 421, the LOI attribute 420 may contribute a total of ten (10) points to the communication score. When the LOI attribute 420 is classified as within the second category 423, the LOI attribute 420 may contribute a total of eight (8) points to the communication score. When the LOI attribute 420 is classified as within the third category 425, the LOI attribute 420 may contribute a total of five (5) points to the communication score. When the LOI attribute 420 is classified as within the fourth category 427, the LOI attribute 420 two (2) points to the communication score, and when the LOI attribute 420 is classified as within the fifth category 429, the LOI attribute 420 may contribute zero (0) points to the communication score. Thus, depending on the classification of the LOI attribute 420 by the scoring engine, the LOI attribute 420 may contribute anywhere from ten (10) to zero (0) points to the total communication score.

The open ends attribute 430 may be correspond to a number of open ended questions included in the communication, and may associated with a first category 432 (e.g., the communication includes one (1) or less open ended questions), a second category 434 (e.g., the communication includes two (2) open ended questions), a third category 436 (e.g., the communication includes three (3) open ended questions), and a fourth category 438 (e.g., the communication includes four (4) or more open ended questions). As explained above with respect to FIG. 1, the scoring engine may determine or otherwise associate the open ends attribute 430 with a particular one of the categories 432, 434, 436, 438.

As shown in FIG. 4, each of the categories 432, 434, 436, 438 may correspond to a particular weighting factor having a particular weight. For example, the first category 432 may correspond to a first weighting factor having a weight of ten (10) points, the second category 434 may correspond to a second weighting factor having a weight of eight (8) points, the third category 436 may correspond to a third weighting factor having a weight of six (6) points, and the fourth category 438 may correspond to a fourth weighting factor having a weight of three (3) points. When the open ends attribute 430 is classified as within the first category 432, the open ends attribute 430 may contribute a total of ten (10) points to the communication score. When the open ends attribute 430 is classified as within the second category 434, the open ends attribute 430 may contribute a total of eight (8) points to the communication score. When the open ends attribute 430 is classified as within the third category 436, the open ends attribute 430 may contribute a total of six (6) points to the communication score. When the open ends attribute 430 is classified as within the fourth category 438, the open ends attribute 430 may contribute three (3) points to the communication score. Thus, depending on the classification of the open ends attribute 430 by the scoring engine, the open ends attribute 430 may contribute anywhere from ten (10) to three (3) points to the total communication score.

In a further example, the question wording attribute 440, may indicate how well the communication questions are written, and may be associated with a first category 442 (e.g., a communication that includes succinctly worded questions), a second category 444 (e.g., a communication that includes questions that are neither succinct, nor excessively long or redundantly worded, etc.), or a third category 446 (e.g., a communication that includes verbosely worded questions or questions that are redundantly worded or unclear).

As shown in FIG. 4, each of the categories 442, 444, 446 may correspond to a particular weighting factor having a particular weight. For example, the first category 442 may correspond to a first weighting factor having a weight of ten (10) points, the second category 444 may correspond to a second weighting factor having a weight of eight (8) points, and the third category 446 may correspond to a third weighting factor having a weight of five (5) points. When the question wording attribute 440 is classified as within the first category 442, the question wording attribute 440 may contribute a total of ten (10) points to the communication score. When the question wording attribute 440 is classified as within the second category 444, the question wording attribute 440 may contribute a total of eight (8) points to the communication score. When the question wording attribute 440 is classified as within the third category 446, the question wording attribute 440 may contribute a total of five (5) points to the communication score. Thus, depending on the classification of the question wording attribute 440 by the scoring engine, the question wording attribute 440 may contribute anywhere from ten (10) to five (5) points to the total communication score.

The number of answer choices attribute 450 may be associated with a number of answer choices representative of the multiple choice questions included in the communication, and may be associated with a first category 452 (e.g., a communication that includes multiple choice questions having between one (1) and eight (8) answer choices), a second category 454 (e.g., a communication that includes multiple choice questions having between nine (9) and fifteen (15) answer choices), a third category 456 (e.g., a communication that includes multiple choice questions having between sixteen (16) and twenty (20) answer choices), and a fourth category 458 (e.g., a communication that includes multiple choice questions having between twenty one (21) or more answer choices).

As shown in FIG. 4, each of the categories 452, 454, 456, 458 may correspond to a particular weighting factor having a particular weight. For example, the first category 452 may correspond to a first weighting factor having a weight of ten (10) points, the second category 454 may correspond to a second weighting factor having a weight of eight (8) points, the third category 456 may correspond to a third weighting factor having a weight of five (5) points, and the fourth category 458 may correspond to a fourth weighting factor having a weight of zero (0) points. When the number of answer choices attribute 450 is classified as within the first category 452, the number of answer choices attribute 450 may contribute a total of ten (10) points to the communication score. When the number of answer choices attribute 450 is classified as within the second category 454, the number of answer choices attribute 450 may contribute a total of eight (8) points to the communication score. When the number of answer choices attribute 450 is classified as within the third category 456, the number of answer choices attribute 450 may contribute a total of five (5) points to the communication score. When the number of answer choices attribute 450 is classified as within the fourth category 458, the number of answer choices attribute 450 may contribute a total of zero (0) points to the communication score. Thus, depending on the classification of the number of answer choices attribute 450 by the scoring engine, the question wording attribute 440 may contribute anywhere from ten (10) to zero (0) points to the total communication score.

The communication compatibility attribute 460 may indicate whether the communication is compatible with the mobile respondent devices (e.g., whether the communication includes elements utilizing Adobe® Flash® platforms), and may be associated with a first category 462 (e.g., a communication that is not compatible with the mobile respondent devices), or a second category 464 (e.g., a communication that is compatible with the mobile respondent devices). As shown in FIG. 4, each of the categories 462, 464 may correspond to a particular weighting factor having a particular weight. For example, the first category 462 may correspond to a first weighting factor having a weight of zero (0) points, and the second category 464 may correspond to a second weighting factor having a weight of ten (10) points. When the communication compatibility attribute 460 is classified as within the first category 462, the communication compatibility attribute 460 may contribute a total of zero (0) points to the communication score. When the communication compatibility attribute 460 is classified as within the second category 464, the communication compatibility attribute 460 may contribute a total of ten (10) points to the communication score. Thus, depending on the classification of the communication compatibility attribute 460 by the scoring engine, the communication compatibility attribute 460 may contribute ten (10) or zero (0) points to the total communication score.

In an aspect, the communication compatibility attribute 460 may also be associated with a deterministic weighting factor (not shown in FIG. 4). When the communication compatibility attribute 460 is classified as within the first category 462, the communication score may be reduced to zero (0) since the communication (or a portion of the communication) is not compatible with the mobile respondent devices (e.g., the mobile respondent devices 162 of FIG. 1).

The use of grids attribute 470 may indicate whether the communication utilizes grid questions, and may be associated with a first category 472 (e.g., a communication that includes grid questions), or a second category 474 (e.g., a communication that does not include grid questions). As shown in FIG. 4, each of the categories 472, 474 may correspond to a particular weighting factor having a particular weight. For example, the first category 472 may correspond to a first weighting factor having a weight of five (5) points, and the second category 474 may correspond to a second weighting factor having a weight of ten (10) points. When the grids attribute 470 is classified as within the first category 472, the grids attribute 470 may contribute a total of five (5) points to the communication score. When the grids attribute 470 is classified as within the second category 474, the grids attribute 470 may contribute a total of ten (10) points to the communication score. Thus, depending on the classification of the grids attribute 470 by the scoring engine, the grids attribute 470 may contribute ten (10) or five (5) points to the total communication score.

The use of rich media attribute 480 may indicate whether images are utilized in the communication (e.g., for illustrative purposes, for aesthetic purposes, or both), and may be associated with a first category 482 (e.g., a communication that uses rich media), or a second category 484 (e.g., a communication that does not use rich media). As shown in FIG. 4, each of the categories 482, 484 may correspond to a particular weighting factor having a particular weight. For example, the first category 482 may correspond to a first weighting factor having a weight of five (5) points, and the second category 484 may correspond to a second weighting factor having a weight of ten (10) points. When the use of rich media attribute 480 is classified as within the first category 482, the use of rich media attribute 480 may contribute a total of five (5) points to the communication score. When the use of rich media attribute 480 is classified as within the second category 484, the use of rich media attribute 480 may contribute a total of ten (10) points to the communication score. Thus, depending on the classification of the use of rich media attribute 480 by the scoring engine, the use of rich media attribute 480 may contribute ten (10) or five (5) points to the total communication score.

The use of audio/video streaming attribute 490 may indicate whether audio and/or video streaming are utilized in the communication, and may be associated with a first category 491 (e.g., a communication that uses audio and/or video streaming in the communication), or a second category 493 (e.g., a communication that does not use audio and/or video streaming in the communication). As shown in FIG. 4, each of the categories 491, 493 may correspond to a particular weighting factor having a particular weight. For example, the first category 491 may correspond to a first weighting factor having a weight of five (5) points, and the second category 493 may correspond to a second weighting factor having a weight of ten (10) points. When the use of audio/video streaming attribute 490 is classified as within the first category 491, the use of audio/video streaming attribute 490 may contribute a total of five (5) points to the communication score. When the use of audio/video streaming attribute 490 is classified as within the second category 493, the use of audio/video streaming attribute 490 may contribute a total of ten (10) points to the communication score. Thus, depending on the classification of the use of audio/video streaming attribute 490 by the scoring engine, the use of audio/video streaming attribute 490 may contribute ten (10) or five (5) points to the total communication score.

The responsive design attribute 495 may indicate whether the communication has been designed with consideration as to how one or more of the various attributes described above affect presentation of the communication at the mobile respondent devices, and may be associated with a first category 497 (e.g., a communication that has been designed with consideration as to how one or more of the various attributes affect presentation of the communication at the mobile respondent devices), or a second category 499 (e.g., a communication that has not been designed with consideration as to how one or more of the various attributes affect presentation of the communication at the mobile respondent devices). For example, using a larger text or font sizes may be beneficial for presentation of the communication at the mobile respondent devices.

As shown in FIG. 4, each of the categories 497, 499 may correspond to a particular weighting factor having a particular weight. For example, the first category 497 may correspond to a first weighting factor having a weight of ten (10) points, and the second category 499 may correspond to a second weighting factor having a weight of five (5) points. When the responsive design attribute 495 is classified as within the first category 497, the responsive design attribute 495 may contribute a total of ten (10) points to the communication score. When the responsive design attribute 495 is classified as within the second category 499, the responsive design attribute 495 may contribute a total of five (5) points to the communication score. Thus, depending on the classification of the responsive design attribute 495 by the scoring engine, the responsive design attribute 495 may contribute ten (10) or five (5) points to the total communication score.

During operation, the scoring engine may classify each of the attributes 402 into the respective categories, as described above, and then apply the corresponding weighting factors to each of the classified attributes to determine the communication score. In an aspect, the communication score may be a weighted average score calculated as the sum of the points determined by applying the respective weighting factors to the corresponding classified attributes, and then dividing by the total number of attributes (e.g., ten (10) in FIG. 4).

In an aspect, the weighted average score may be further weighted by multiplying the weighted average by a deterministic weighting factor. The deterministic weighting factor may have a value of one (1) or zero (0) depending on the classification of the corresponding communication attribute. For example, when the communication compatibility attribute 460 is classified within the first category 462, a deterministic weighting factor associated with the communication compatibility attribute 460 may be set to zero (0), causing the communication score to become zero (0) and indicate that the communication is not suitable for presentation at the mobile respondent devices. When the communication compatibility attribute 460 is classified within the second category 464, the deterministic weighting factor associated with the communication compatibility attribute 460 may be set to one (1), and may not change the communication score.

In an additional or alternative aspect, the weighted average score may be further weighted by multiplying the weighted average by more than one deterministic weighting factor. For example, a first deterministic weighting factor may be associated with the communication compatibility attribute 460, and a second deterministic weighting factor may be associated with the LOI attribute 420. When the communication compatibility attribute 460 is classified within the first category 462, a deterministic weighting factor associated with the communication compatibility attribute 460 may be set to zero (0), causing the communication score to become zero (0) and indicate that the communication is not suitable for presentation at the mobile respondent devices. When the communication compatibility attribute 460 is classified within the second category 464, the deterministic weighting factor associated with the communication compatibility attribute 460 may be set to one (1), and may not change the communication score. Additionally, when the LOI attribute 420 is classified within the fifth category 429, the second deterministic weighting factor associated with the LOI attribute 420 may be set to zero (0), causing the communication score to become zero (0) and indicate that the communication is not suitable for presentation at the mobile respondent devices (e.g., due to an excessive estimated amount of time to complete the communication). When the LOI attribute 420 is classified within any one of the other categories 421, 423, 425, 427, the deterministic weighting factor associated with the LOI attribute 420 may be set to one (1), and may not change the communication score. Thus, more than one deterministic weighting factor may be used to generate the communication score.

In other aspects, the communication score may be a raw score calculated as the sum of the points determined by applying the respective weighting factors to the corresponding classified attributes. The example techniques for calculating the communication score provided herein are provided for purposes of illustration and understanding, rather than limitation, and it is to be understood that other techniques may be used to calculate the communication score without departing from the scope of the present disclosure.

Referring to FIG. 5, a flow chart of an exemplary method of determining whether a communication is suitable for distribution to a mobile respondent device is shown and designated 500. In an aspect, the method 500 may be performed by device 110 of FIG. 1 or the client device 150 of FIG. 1. At 510, the method includes receiving communication data descriptive of a communication to be distributed to a plurality of respondents. In an aspect, the communication data may be the communication data 152 of FIG. 1 and may be received at the device 110 of FIG. 1 from the client device 150 of FIG. 1. At 520, the method 500 includes analyzing the communication data to identify one or more attributes of the communication. In an aspect, the one or more attributes may include the attributes described with reference to FIGS. 1-4, or a combination thereof, and may be analyzed by the scoring engine 130 of FIG. 1.

At 530, the method 500 includes generating a communication score for the communication based on the one or more attributes of the communication. The communication score may be representative of a suitability of the communication for presentation at and/or distribution to a mobile device, such as one of the mobile respondent devices 162 of FIG. 1. In an aspect, weighting factors may be applied to the one or more attributes to generate the communication score, as described with reference to FIGS. 1 and 4. At 540, the method 500 includes determining distribution information for the communication based at least in part on the communication score. The distribution information may identify a set of respondents of the plurality of respondents to receive the communication. In an aspect, the distribution information may be determined by a communication distribution engine (e.g., the communication distribution engine 132 of FIG. 1).

The method 500 may enable a entity (e.g., an entity operating the device 110 of FIG. 1) to increase stickiness of the respondents enrolled with the entity. This may be particularly true with respect to mobile respondents, because the method 500 enables the entity to distribute communications that are less likely to frustrate the enrolled respondents. Additionally, communications distributed according to the method 500 may, as described in conjunction with reference to FIG. 1, provide more meaningful feedback to the client, as the mobile respondents may be more likely to complete a communication distributed according to the method 500.

The present application incorporates-by-reference the entirety of International Application No. PCT/US2015/029493, filed May 6, 2015, associated with Publication No. WO2015171782 A1, titled “Scoring tool for research surveys deployed in a mobile environment,” for all purposes. The present application incorporates-by-reference the entirety of U.S. patent application Ser. No. 14/273,402, filed May 8, 2014, associated with Publication No. US 2015-0324811 A1, titled “Scoring tool for research surveys deployed in a mobile environment,” for all purposes. In some embodiments, an exemplary method is provided. The method comprises receiving, by a processor, communication data descriptive of a communication to be distributed to a plurality of respondents; analyzing, by the processor, the communication data to identify one or more attributes of the communication; generating, by the processor, a communication score for the communication based on the one or more attributes of the communication, wherein the communication score is representative of a suitability of the communication for presentation at a mobile device; applying one or more weighting factors to the one or more attributes to generate the communication score, wherein each of the one or more weighting factors corresponds to a particular attribute of the one or more attributes, wherein the one or more weighting factors include a deterministic weighting factor; applying the deterministic weighting factor to a corresponding attribute of the one or more attributes; determining whether the corresponding attribute satisfies the deterministic weighting factor; modifying the communication score when the corresponding attribute satisfies the deterministic weighting factor; and refraining from modifying the communication score when the corresponding attribute does not satisfy the deterministic weighting factor. In some embodiments, the one or more attributes of the communication include a length of interview (LOI) attribute, a number of open ends attribute, a length of questions attribute, a number of answer choices attribute, a grids attribute, a rich media attribute, an audiovisual attribute, a text size attribute, a control buttons attribute, or a combination thereof. In some embodiments, modifying the communication score when the corresponding attribute satisfies the deterministic weighting factor causes the communication score to indicate that the communication is not suitable for presentation at the mobile device. In some embodiments, the method includes: generating a scoring report based on analyzing the communication and the communication score, wherein the scoring report includes information descriptive of a set of attributes that reduced the communication score; and initiating transmission of the scoring report to an entity that created the communication data.

In some embodiments, an exemplary apparatus is provided. The apparatus comprises a processor; and a memory communicatively coupled to the processor, the memory storing instructions that, when executed by the processor, cause the processor to perform operations including: receiving communication data descriptive of a communication to be distributed to a plurality of respondents; analyzing the communication data to identify one or more attributes of the communication; generating a communication score for the communication based on the one or more attributes of the communication, wherein the communication score is representative of a suitability of the communication for presentation at a mobile device; applying one or more weighting factors to the one or more attributes to generate the communication score, wherein each of the one or more weighting factors corresponds to a particular attribute of the one or more attributes, wherein the one or more weighting factors include a deterministic weighting factor; applying the deterministic weighting factor to a corresponding attribute of the one or more attributes; determining whether the corresponding attribute satisfies the deterministic weighting factor; modifying the communication score when the corresponding attribute satisfies the deterministic weighting factor; and refraining from modifying the communication score when the corresponding attribute does not satisfy the deterministic weighting factor. In some embodiments, the operations include selecting the one or more weighting factors from among a plurality of weighting factors. In some embodiments, the one or more weighting factors are selected based on demographic criteria indicating a target demographic associated with the communication. In some embodiments, the one or more attributes of the communication include a length of interview (LOI) attribute, a number of open ends attribute, a length of questions attribute, a number of answer choices attribute, a grids attribute, a rich media attribute, an audiovisual attribute, a text size attribute, a control buttons attribute, or a combination thereof. In some embodiments, modification of the communication score when the corresponding attribute satisfies the deterministic weighting factor causes the communication score to indicate that the communication is not suitable for presentation at the mobile device. In some embodiments, the operations include: generating a scoring report based on analyzing the communication and the communication score, wherein the scoring report includes information descriptive of a set of attributes that reduced the communication score; and initiating transmission of the scoring report to an entity that created the communication data. In some embodiments, the operations include: receiving communication feedback from at least a portion of the set of respondents, the communication feedback including responses to questions included in the communication; and analyzing the communication feedback to determine performance metrics associated with a relationship between the communication feedback and the communication score. In some embodiments, the operations include determining whether to modify at least one weighting factor of the one or more weighting factors based on the performance metrics. In some embodiments, modifying the at least one weighting factor includes increasing an amount of weight given to the at least one weighting factor, reducing an amount of weight given to the at least one weighting factor, eliminating the at least one weighting factor, introducing a new weighting factor, combining two or more weighting factors, or a combination thereof.

In some embodiments, an exemplary computer-readable storage device is provided. The computer-readable storage device stores instructions that, when executed by a processor, cause the processor to perform operations comprising: receiving communication data descriptive of a communication to be distributed to a plurality of respondents; analyzing the communication data to identify one or more attributes of the communication; generating a communication score for the communication based on the one or more attributes of the communication, wherein the communication score is representative of a suitability of the communication for presentation at a mobile device; applying one or more weighting factors to the one or more attributes to generate the communication score, wherein each of the one or more weighting factors corresponds to a particular attribute of the one or more attributes, wherein the one or more weighting factors include a deterministic weighting factor; applying the deterministic weighting factor to a corresponding attribute of the one or more attributes; determining whether the corresponding attribute satisfies the deterministic weighting factor; modifying the communication score when the corresponding attribute satisfies the deterministic weighting factor; and refraining from modifying the communication score when the corresponding attribute does not satisfy the deterministic weighting factor. In some embodiments, the one or more attributes of the communication include a length of interview (LOI) attribute, a number of open ends attribute, a length of questions attribute, a number of answer choices attribute, a grids attribute, a rich media attribute, an audiovisual attribute, a text size attribute, a control buttons attribute, or a combination thereof. In some embodiments, the operations include: identifying a first set of weighting factors and a second set of weighting factors, wherein the first set of weighting factors are associated with a first respondent device type, wherein the second set of weighting factors are associated with a second respondent device type; applying the first set of weighting factors to the one or more attributes to generate a first communication score; and applying the second set of weighting factors to the one or more attributes to generate a second communication score, wherein the communication score includes information associated with the first communication score and the second communication score. In some embodiments, the first respondent device type and the second respondent device type are different types of mobile devices. In some embodiments, an amount of weight given to a particular weighting factor of the one or more weighting factors is increased based on demographic criteria indicating a target demographic associated with the communication or is reduced based on demographic criteria indicating a target demographic associated with the communication.

In some embodiments, another exemplary method is provided. The method comprises receiving, by a processor, communication data descriptive of a communication to be distributed to a plurality of respondents; analyzing, by the processor, the communication data to identify one or more attributes of the communication; generating, by the processor, a communication score for the communication based on the one or more attributes of the communication, wherein the communication score is representative of a suitability of the communication for presentation at a mobile device; generating a scoring report based on analyzing the communication and the communication score, wherein the scoring report includes information descriptive of a set of attributes that reduced the communication score; initiating transmission of the scoring report to an entity that created the communication data; determining whether the communication score satisfies a first threshold score, wherein the first threshold score corresponds to a communication score representative of a communication that is suitable for presentation at the mobile device; in response to a determination that the communication score satisfies the first threshold score: determining distribution information for the communication based at least in part on the communication score, wherein the distribution information identifies a set of respondents of the plurality of respondents to receive the communication; authorizing distribution of the communication to the set of respondents identified by the distribution information; in response to a determination that the communication score does not satisfy the first threshold score: determining whether the communication score satisfies a second threshold score, wherein the second threshold score corresponds to a communication score representative of a communication unsuitable for presentation at the mobile device; in response to a determination that the communication score does not satisfy the second threshold score, determining one or more recommendations for improving a subsequent scoring of the communication, wherein the one or more recommendations are determined based on the set of attributes that reduced the communication score below the first threshold score, wherein the one or more recommendations for improving the subsequent scoring of the communication are configured to cause the subsequent scoring of the communication to satisfy the first threshold score, and wherein the scoring report includes the one or more recommendations for improving the subsequent scoring of the communication. In some embodiments, an entity may refer to a market research entity. In some embodiments, a communication may refer to a survey (e.g., for the purposes of conducting market research). In some embodiments, a score may be replaced by any indicator. In some embodiments, the various embodiments described herein disclose generating a score (e.g., a communication score) and output on how to improve the score based on analyzing the highest-weighted attributes. In some embodiments, the terms “communication” and “data” may be used interchangeably. In other embodiments, a communication may comprise data that may be referred to as communication data.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. (canceled)

2. A method for determining suitability of data presentation on a mobile device, the method comprising:
receiving, by one or more processors, survey data descriptive of a survey to be distributed to a plurality of respondents;
analyzing, by the one or more processors, the survey data to identify one or more attributes of the survey;
generating, by the one or more processors, a survey score based on the one or more attributes of the survey, wherein the survey score is representative of a suitability of the survey for presentation at a mobile device;
applying, by the one or more processors, one or more weighting factors to the one or more attributes to generate the survey score, wherein each of the one or more weighting factors corresponds to a particular attribute of the one or more attributes, wherein the one or more weighting factors include a deterministic weighting factor;
applying, by the one or more processors, the deterministic weighting factor to a corresponding attribute of the one or more attributes;
determining, by the one or more processors, whether the corresponding attribute satisfies the deterministic weighting factor;
modifying, by the one or more processors, the survey score when the corresponding attribute satisfies the deterministic weighting factor;
refraining, by the one or more processors, from modifying the survey score when the corresponding attribute does not satisfy the deterministic weighting factor.

3. The method of claim 2, wherein the one or more attributes of the survey include a length of interview (LOI) attribute, a number of open ends attribute, a length of questions attribute, a number of answer choices attribute, a grids attribute, a rich media attribute, an audiovisual attribute, a text size attribute, a control buttons attribute, or a combination thereof.

4. The method of claim 2, wherein modifying the survey score when the corresponding attribute satisfies the deterministic weighting factor causes the survey score to indicate that the survey is not suitable for presentation at the mobile device.

5. The method of claim 2, further comprising:
generating a scoring report based on analyzing the survey and the survey score, wherein the scoring report includes information descriptive of a set of attributes that reduced the survey score; and
initiating transmission of the scoring report to an entity that created the survey data.

6. An apparatus comprising:
a processor; and
a memory communicatively coupled to the processor, the memory storing instructions that, when executed by the processor, cause the processor to perform operations including:
receiving survey data descriptive of a survey to be distributed to a plurality of respondents;
analyzing the survey data to identify one or more attributes of the survey;
generating a survey score for the survey based on the one or more attributes of the survey, wherein the survey score is representative of a suitability of the survey for presentation at a mobile device;
applying one or more weighting factors to the one or more attributes to generate the survey score, wherein each of the one or more weighting factors corresponds to a particular attribute of the one or more attributes, wherein the one or more weighting factors include a deterministic weighting factor;
applying the deterministic weighting factor to a corresponding attribute of the one or more attributes;
determining whether the corresponding attribute satisfies the deterministic weighting factor;
modifying the survey score when the corresponding attribute satisfies the deterministic weighting factor;
refraining from modifying the survey score when the corresponding attribute does not satisfy the deterministic weighting factor.

7. The apparatus of claim 6, wherein the operations include selecting the one or more weighting factors from among a plurality of weighting factors.

8. The apparatus of claim 6, wherein the one or more weighting factors are selected based on demographic criteria indicating a target demographic associated with the survey.

9. The apparatus of claim 6, wherein the one or more attributes of the survey include a length of interview (LOI) attribute, a number of open ends attribute, a length of questions attribute, a number of answer choices attribute, a grids attribute, a rich media attribute, an audiovisual attribute, a text size attribute, a control buttons attribute, or a combination thereof.

10. The apparatus of claim 6, wherein modification of the survey score when the corresponding attribute satisfies the deterministic weighting factor causes the survey score to indicate that the survey is not suitable for presentation at the mobile device.

11. The apparatus of claim 6, wherein the operations include:
generating a scoring report based on analyzing the survey and the survey score, wherein the scoring report includes information descriptive of a set of attributes that reduced the survey score; and
initiating transmission of the scoring report to an entity that created the survey data.

12. The apparatus of claim 6, wherein the operations include:
receiving survey feedback from at least a portion of the plurality of respondents, the survey feedback including responses to questions included in the survey; and
analyzing the survey feedback to determine performance metrics associated with a relationship between the survey feedback and the survey score.

13. The apparatus of claim 12, wherein the operations include determining whether to modify at least one weighting factor of the one or more weighting factors based on the performance metrics.

14. The apparatus of claim 13, wherein modifying the at least one weighting factor includes increasing an amount of weight given to the at least one weighting factor, reducing an amount of weight given to the at least one weighting factor, eliminating the at least one weighting factor, introducing a new weighting factor, combining two or more weighting factors, or a combination thereof.

15. A method comprising:
receiving, by one or more processors, survey data descriptive of a survey to be distributed to a plurality of respondents;
analyzing, by the one or more processors, the survey data to identify one or more attributes of the survey;
generating, by the one or more processors, a survey score for the survey based on the one or more attributes of the survey, wherein the survey score is representative of a suitability of the survey for presentation at a mobile device;
generating a scoring report based on analyzing the survey and the survey score, wherein the scoring report includes information descriptive of a set of attributes that reduced the survey score;
initiating transmission of the scoring report to an entity that created the survey data;
determining whether the survey score satisfies a first threshold score, wherein the first threshold score corresponds to a survey score representative of a survey that is suitable for presentation at the mobile device;
in response to a determination that the survey score satisfies the first threshold score: determining distribution information for the survey based at least in part on the survey score, wherein the distribution information identifies a set of respondents of the plurality of respondents to receive the survey, and authorizing distribution of the survey to the set of respondents identified by the distribution information;
in response to a determination that the survey score does not satisfy the first threshold score:
determining whether the survey score satisfies a second threshold score, wherein the second threshold score corresponds to a survey score representative of a survey unsuitable for presentation at the mobile device,
in response to a determination that the survey score does not satisfy the second threshold score, determining one or more recommendations for improving a subsequent scoring of the survey, wherein the one or more recommendations are determined based on the set of attributes that reduced the survey score below the first threshold score, wherein the one or more recommendations for improving a subsequent scoring of the survey are configured to cause the subsequent scoring of the survey to satisfy the first threshold score, and wherein the scoring report includes the one or more recommendations for
